(19) United States
(12) Patent Application Publication
(10) Pub. No.: US 2013/0070949 A1
(43) Pub. Date: Mar. 21, 2013

(54) SOUND-REPRODUCING APPARATUS, LIGHTING APPARATUS, AND SUSPENDED OPENING AND CLOSING APPARATUS

(71) Applicant: Yohei FUKUMA, Chiba (JP)

(72) Inventor: Yohei FUKUMA, Chiba (JP)

(73) Assignee: SONY CORPORTION, Tokyo (JP)

(21) Appl. No.: 13/589,435

(22) Filed: Aug. 20, 2012

(30) Foreign Application Priority Data
Sep. 16, 2011 (JP) 2011-203585

(51) Int. Cl. H04R 1/02; F16H 21/46; F21V 21/00

(52) U.S. Cl. 381/336; 362/249.01; 74/96

(57) ABSTRACT

A sound-reproducing apparatus includes plural coupling portions, plural rods, plural shell portions, an actuator, and first, second, and third speakers. The coupling portions are disposed at positions corresponding to vertices of an assumed first regular tetrahedron and second regular tetrahedron in a duality relation. The rods connect adjacent coupling portions with each other among the coupling portions. The shell portions are joined to the rods. The actuator is disposed outside one coupling portion selected from the coupling portions with respect to a center of the first regular tetrahedron or second regular tetrahedron, and the actuator is connected with the one coupling portion. The first, second, and third speakers are disposed on, of the four coupling portions disposed at positions corresponding to the vertices of the one of the first and second regular tetrahedra including the one coupling portion, three coupling portions excluding the one coupling portion.

### BACKGROUND

The present disclosure relates to a sound-reproducing apparatus, a lighting apparatus, and a suspended opening and closing apparatus. More particularly, the present disclosure relates to a sound-reproducing apparatus, a lighting apparatus, and a suspended opening and closing apparatus having a mechanical configuration in which plural coupling portions are coupled to one another, and in which two states are readily changed to each other by an operation made on one coupling portion.

There have been attempted a number of designs for a structure composed of a combination of plural members which move while maintaining regularity, so that the structure can be shifted between a state of being small folded (hereinafter referred to as “an accommodated state” as appropriate) and a state of being largely expanded (hereinafter referred to as “an expanded state” as appropriate).

Such a structure, for example, is applied to a solar cell panel, an antenna and the like that are mounted on an artificial satellite. In addition thereto, a little closer to home, such a structure is also applied to household furniture, electrical appliances and the like. For example, Japanese Patent Laid-open No. 2000-183640 (hereinafter referred to as Patent Document 1) discloses one kind of an expanding frame structure. In this structure, a truncated pyramid-like frame structure serves as a base element. The expanding frame structure is configured by coupling a plurality of the truncated pyramid-like frame structures with a side surface thereof being shared, and is configured such that ridge lines can be translated synchronously while retaining the truncated pyramid-like outer shape of the frame structure.

However, for the technique disclosed in Patent Document 1, there are required plural actuators in order to smoothly transform the expanding frame structure from the accommodated state to the expanded state. In addition, the configuration for synchronously moving the frame structures is complicated, and thus a design cost is increased with an increase in the number of the base elements.

The technique disclosed in Patent Document 1 utilizes a property of regular polyhedrons that the internal center of each of the surfaces composing a regular polyhedron circumscribes a sphere having a certain radius (inscribed sphere). Incidentally, a toy utilizing duality of regular tetrahedra called “SwitchPitch”, manufactured by Hoberman Associates, Inc. (“SWITCHPITCH” is a registered trademark of RANGS JAPAN Inc.), is disclosed on the Internet: <URL: http://www.hoberman.com/fold/Switchpitch/switchpitch.htm> Hoberman Associates, Inc., 2003, retrieved on Sep. 5, 2011.

### SUMMARY

It is desirable to realize mutual changing between an accommodated state and an expanded state with a simpler structure.

According to one preferred embodiment of the present disclosure, there is provided a sound-reproducing apparatus including: plural coupling portions disposed at positions corresponding to vertices of an assumed first regular tetrahedron and second regular tetrahedron in a duality relation with each other; plural rods connecting adjacent coupling portions to each other among the plural coupling portions; plural shell portions joined to the plural rods; an actuator disposed outside one coupling portion selected from the plural coupling portions with respect to a center of the first regular tetrahedron or a center of the second regular tetrahedron, the actuator being connected with the one coupling portion; and first, second, and third speakers disposed on, of the four coupling portions disposed at positions corresponding to the vertices of the one of the first and second regular tetrahedra including the one coupling portion, three coupling portions excluding the one coupling portion.

According to another preferred embodiment of the present disclosure, there is provided a lighting apparatus including: plural coupling portions disposed at positions corresponding to vertices of an assumed first regular tetrahedron and second regular tetrahedron in a duality relation with each other; plural rods connecting adjacent coupling portions to each other among the plural coupling portions; plural shell portions joined to the plural rods; an actuator disposed outside one coupling portion selected from the plural coupling portions with respect to a center of the first regular tetrahedron or a center of the second regular tetrahedron, the actuator being connected with the one coupling portion; and plural light emitting portions disposed on at least part of the plural coupling portions or the plural rods selected from a set of the plural coupling portions and the plural rods so as to have symmetry.

According to still another preferred embodiment of the present disclosure, there is provided a suspended opening and closing apparatus including: plural coupling portions disposed at positions corresponding to vertices of an assumed first regular tetrahedron and second regular tetrahedron in a duality relation, the first regular tetrahedron having a top portion thereof on a upper side in a vertical direction; plural rods connecting adjacent coupling portions to each other among the plural coupling portions; and an actuator disposed above one of the plural coupling portions disposed at a position corresponding to the top portion of the first regular tetrahedron, the actuator being connected with the one coupling portion.

According to yet another embodiment of the present disclosure, there is provided a suspended opening and closing apparatus having a first state and a second state, the first state and the second state being changed to each other by an operation of an actuator disposed above, wherein plural members belonging to a first group are disposed so as to correspond to vertices of a first regular tetrahedron, and plural members belonging to a second group are disposed so as to correspond to vertices of a second regular tetrahedron, and the first regular tetrahedron and the second regular tetrahedron are in a duality relation in one of the first state and the second state.

In the above embodiments of the present disclosure, the plural coupling portions are coupled to one another by the plural rods. When a first regular tetrahedron and a second regular tetrahedron are supposed, the plural coupling portions are disposed at positions corresponding to the vertices of the first regular tetrahedron and the second regular tetrahedron.

Here, in the embodiments of the present disclosure, the first regular tetrahedron and the second regular tetrahedron are in a duality relation. In this specification, the wording that two regular polyhedra “are in or have a duality relation” means that the vertices of one of the regular polyhedra are located at positions corresponding to the internal centers of the surfaces composing the other regular polyhedron. Meanwhile, in this specification, the wording that a regular polyhedron “has duality” means that, when a regular polyhedron obtained by connecting the internal centers of surfaces composing another regular polyhedral is assumed, the regular polyhedron whose vertices being located at the internal centers of the surfaces of the other regular polyhedron becomes similar to the original regular polyhedron. For example, a regular hexahedron has duality, and a regular hexahedron obtained by connecting the internal centers of surfaces composing a regular octahedron has a duality relation with the regular octahedron.

In the embodiments of the present disclosure, the accommodated state and the expanded state are mutually shifted to each other, and the relative positional relationships of the vertices of each regular tetrahedron are reserved before and after the shifting. In other words, the first regular tetrahedron in the accommodated state, and the first regular tetrahedron in the expanded state are similar to each other. Similarly, the second regular tetrahedron in the accommodated state, and the second regular tetrahedron in the expanded state are similar to each other. For example, if the vertices of the first regular tetrahedron are located at positions corresponding to the internal centers of the surfaces composing the second regular tetrahedron in the accommodated state, in the expanded state, the first regular tetrahedron and the second regular tetrahedron are congruent to each other and are so disposed as to be inverted from each other.

Each of the coupling portions is coupled to coupling portions adjacent thereto by the rods. Therefore, the coupling portions disposed at positions corresponding to the vertices of the first regular tetrahedron are coupled to three of the coupling portions disposed at positions corresponding to the vertices of the second regular tetrahedron.

In the above embodiments of the present disclosure, the actuator is coupled to one of the coupling portions. The actuator is expanded and contracted, thereby moving the coupling portion to which the actuator is connected. The plural coupling portions are disposed at positions corresponding to the vertices of the first regular tetrahedron and at positions corresponding to the vertices of the second regular tetrahedron which has a duality relation with the first regular tetrahedron. In addition, each adjacent two coupling portions are coupled to each other by one of the rods.

Therefore, when one of the plural coupling portions is moved, the motion of the moved coupling portion is transmitted to the remaining coupling portions sequentially. Thus, the plural coupling portions and the plural rods are moved synchronously with each other. As the plural coupling portions and the plural rods move synchronously with each other, the state is shifted between the accommodated state and the expanded state.

When the plural shell portions are joined to the plural rods, along with the movement of the plural coupling portions and the plural rods, at least part of the plural shell portions overlaps with each other, or the distance between adjacent shell portions becomes large.

When speakers are disposed on at least part of the coupling portions, selected from the set of the plural coupling portions, different sound effects are produced depending on whether the sound-reproducing apparatus is in the accommodated state or the expanded state. When plural light emitting portions are disposed either replacing the speakers or together with the speakers, different light distribution is provided depending on whether the lighting apparatus or the sound-reproducing apparatus is in the accommodated state or the expanded state.

When each of the plural shell portions has a quasi-periodic shape or form on the surface thereof, the design property of the sound-reproducing apparatus or the lighting apparatus is enhanced. In this specification, the wording “having a quasi-periodic shape or form” means that the shape or form has an orderliness based on some sort of a rule or rules.

As set forth hereinabove, according to embodiments of the present disclosure, the mutual changing between the accommodated state and the expanded state can be realized with a simpler structure.

### BRIEF DESCRIPTION OF THE DRAWINGS

FIGS. 1A and 1B are respectively a front view showing an accommodated state of a sound-reproducing apparatus according to a first embodiment of the present disclosure, and a rear view showing the accommodated state of the sound-reproducing apparatus according to the first embodiment of the present disclosure;

FIGS. 2A and 2B are respectively a right-hand side view showing an accommodated state of a sound-reproducing portion included in the sound-reproducing apparatus according to the first embodiment of the present disclosure, and a left-hand side view showing the accommodated state of the sound-reproducing portion;

FIGS. 3A and 3B are respectively a top plan view showing the accommodated state of the sound-reproducing portion, and a bottom plan view showing the accommodated state of the sound-reproducing portion;

FIGS. 4A and 4B are respectively a front view showing an expanded state of the sound-reproducing portion, and a rear view showing the expanded state of the sound-reproducing portion;

FIGS. 5A and 5B are respectively a right-hand side view showing the expanded state of the sound-reproducing portion, and a left-hand side view showing the expanded state of the sound-reproducing portion;

FIGS. 6A and 6B are respectively a top plan view showing the expanded state of the sound-reproducing portion, and a bottom plan view showing the expanded state of the sound-reproducing portion;

FIGS. 7A and 7B are respectively a perspective view showing the accommodated state of the sound-reproducing portion, and a perspective view showing the expanded state of the sound-reproducing portion;

FIGS. 8A and 8B are respectively a front view showing an accommodated state of a suspended opening and closing apparatus included in the sound-reproducing apparatus according to the first embodiment of the present disclosure, and a rear view showing the accommodated state of the suspended opening and closing apparatus;

FIGS. 9A and 9B are respectively a right-hand side view showing an accommodated state of a support structure included in the sound-reproducing apparatus according to the first embodiment of the present disclosure, and a left-hand side view showing the accommodated state of the support structure;

FIGS. 10A and 10B are respectively a top plan view showing the accommodated state of the support structure, and a bottom plan view showing the accommodated state of the support structure;

FIGS. 11A and 11B are respectively a front view showing an expanded state of the support structure, and a rear view showing the expanded state of the support structure;

FIGS. 12A and 12B are respectively a right-hand side view showing the expanded state of the support structure, and a left-hand side view showing the expanded state of the support structure;

FIGS. 13A and 13B are respectively a top plan view showing the expanded state of the support structure, and a bottom plan view showing the expanded state of the support structure;

FIGS. 14A and 14B are respectively a perspective view showing the accommodated state of the support structure, and a perspective view showing the expanded state of the support structure;

FIGS. 15A and 15B are respectively a schematic view showing one of plural joint sites when viewed from the center of the support structure, and a schematic view explaining a movable range of a rod with respect to the joint site;

FIGS. 16A and 16B are schematic line diagrams explaining the disposition of three speakers;

FIGS. 17A and 17B are schematic line diagrams explaining the disposition of the joint sites and rods in the accommodated state;

FIGS. 18A and 18B are schematic line diagrams explaining the disposition of the joint sites and rods in the expanded state;

FIGS. 19A and 19B are respectively a front view showing an accommodated state of a lighting apparatus according to a second embodiment of the present disclosure, and a rear view showing the accommodated state of the lighting apparatus according to the second embodiment of the present disclosure;

FIGS. 20A and 20B are respectively a right-hand side view showing an accommodated state of an illuminator included in the lighting apparatus according to the second embodiment of the present disclosure, and a left-hand side view showing the accommodated state of the illuminator;

FIGS. 21A and 21B are respectively a top plan view showing the accommodated state of the illuminator, and a bottom plan view showing the accommodated state of the illuminator;

FIGS. 22A and 22B are respectively a front view showing the accommodated state of the illuminator, and a rear view showing the accommodated state of the illuminator;

FIGS. 23A and 23B are respectively a right-hand side view showing an expanded state of the illuminator, and a left-hand side view showing the expanded state of the illuminator;

FIGS. 24A and 24B are respectively a top plan view showing the expanded state of the illuminator, and a bottom plan view showing the expanded state of the illuminator;

FIGS. 25A and 25B are respectively a perspective view showing the accommodated state of the illuminator, and a perspective view showing the expanded state of the illuminator;

FIGS. 26A to 26D are schematic views showing the joint sites when viewed from the center of the support structure;

FIGS. 27A to 27D are schematic views showing the joint sites when viewed from the center of the support structure;

FIGS. 28A and 28B are respectively a front view showing an accommodated state of a sound-reproducing apparatus according to a third embodiment of the present disclosure, and a rear view showing the accommodated state of the sound-reproducing apparatus according to the third embodiment of the present disclosure;

FIGS. 29A and 29B are respectively a right-hand side view showing an accommodated state of a sound-reproducing portion included in the sound-reproducing apparatus according to the third embodiment of the present disclosure, and a left-hand side view showing the accommodated state of the sound-reproducing portion;

FIGS. 30A and 30B are respectively a top plan view showing the accommodated state of the sound-reproducing portion, and a bottom plan view showing the accommodated state of the sound-reproducing portion;

FIGS. 31A and 31B are respectively a front view showing an expanded state of the sound-reproducing portion, and a rear view showing the expanded state of the sound-reproducing portion;

FIGS. 32A and 32B are respectively a right-hand side view showing the expanded state of the sound-reproducing portion, and a left-hand side view showing the expanded state of the sound-reproducing portion;

FIGS. 33A and 33B are respectively a top plan view showing the expanded state of the sound-reproducing portion, and a bottom plan view showing the expanded state of the sound-reproducing portion;

FIGS. 34A and 34B are respectively a perspective view showing the accommodated state of the sound-reproducing portion, and a perspective view showing the expanded state of the sound-reproducing portion;

FIGS. 35A and 35B are respectively a front view showing an accommodated state of a support structure included in the sound reproducing apparatus according to the third embodiment, and a rear view showing the accommodated state of the support structure;

FIGS. 36A and 36B are respectively a right-hand side view showing the accommodated state of the support structure, and a left-hand side view showing the accommodated state of the support structure;

FIGS. 37A and 37B are respectively a top plan view showing the accommodated state of the support structure, and a bottom plan view showing the accommodated state of the support structure;

FIGS. 38A to 38D are schematic views each showing joint sites when viewed from the center of the support structure;

FIGS. 39A to 39D are schematic views each showing the joint sites when viewed from the center of the support structure;

FIGS. 40A and 40B are respectively a perspective view showing the accommodated state of the support structure, and a perspective view showing an example of the sound-reproducing portion in which reflecting members are disposed on the inner side of plural panels; and

FIGS. 41A and 41B are views showing a case where the sound-reproducing apparatus is installed on the ceiling of a dining room.

### DETAILED DESCRIPTION OF THE PREFERRED EMBODIMENTS

Hereinafter, a sound-reproducing apparatus, a lighting apparatus, and a suspended opening and closing apparatus according to preferred embodiments of the present disclosure will be described in detail with reference to the accompanying drawings. The description will be given below in accordance with the following order.

### 1. First Embodiment

### [Outline of Configuration of Sound-Reproducing Apparatus]

(Joint Sites and Rods)

(Panels)

(Actuator)

(Speakers)

### [Expanding Mechanism]

### 2. Second Embodiment

### [Outline of Configuration of Lighting Apparatus]

(Joint Sites and Rods)

(Light Emitting Portions)

(Panels)

### 3. Third Embodiment

### [Outline of Configuration of Sound-Reproducing Apparatus]

(Joint Sites and Rods)

(Speakers and Light Emitting Portions)

(Panels)

### 4. Fourth Embodiment

### [Outline of Configuration of Suspended Opening and Closing Apparatus]

### 5. Fifth Embodiment

### [Outline of Configuration of Suspended Opening and Closing Apparatus]

### 6. Modifications

It is noted that the embodiments which will be described below are preferred concrete examples of a sound-reproducing apparatus, a lighting apparatus, and a suspended opening and closing apparatus. Although various kinds of technically preferred limitations are given in the following description, a sound-reproducing apparatus, a lighting apparatus, and a suspended opening and closing apparatus according to embodiments of the present disclosure are by no means limited to those described below unless otherwise specified.

### 1. First Embodiment

### [Outline of Configuration of Sound-Reproducing Apparatus]

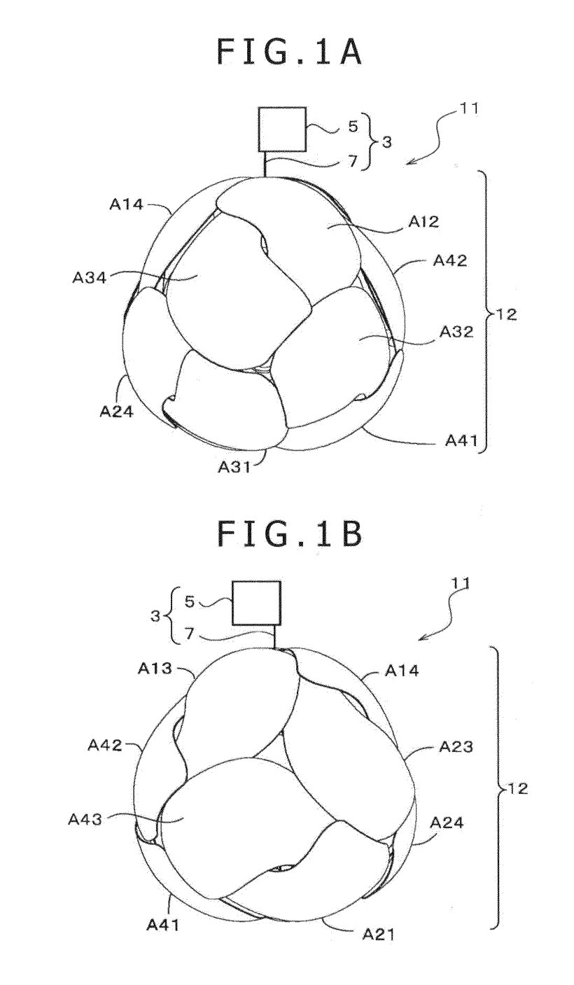

FIG. 1A is a front view showing an accommodated state of a sound-reproducing apparatus according to a first embodiment of the present disclosure. FIG. 1B is a rear view showing the accommodated state of the sound-reproducing apparatus according to the first embodiment of the present disclosure.

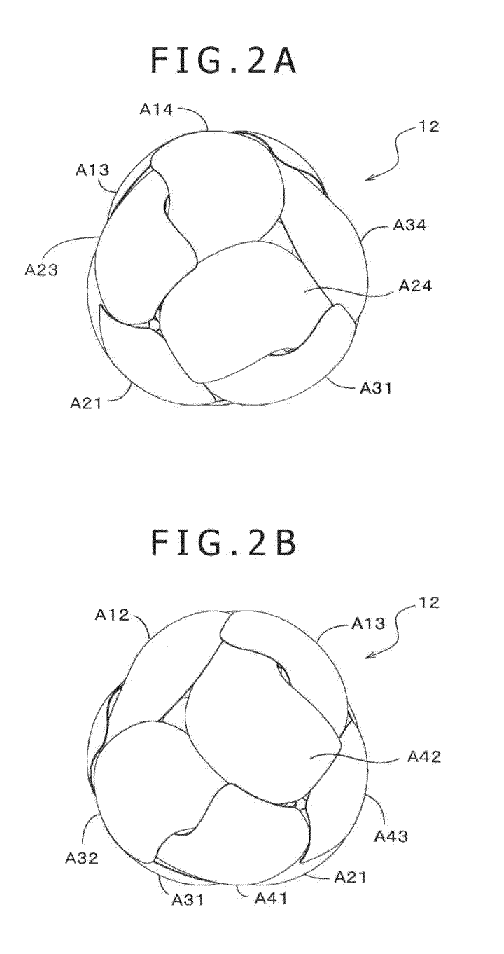

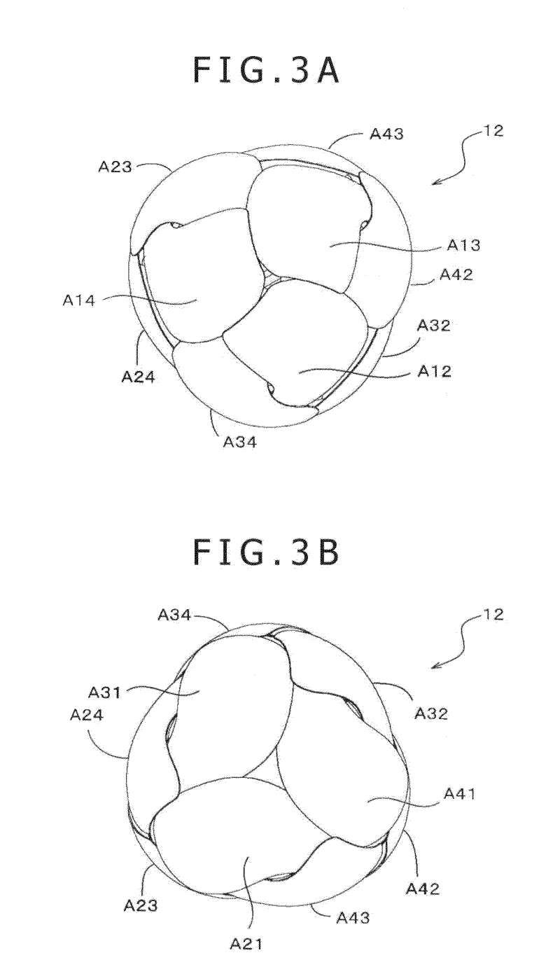

FIG. 2A is a right-hand side view showing an accommodated state of a sound-reproducing portion included in the sound-reproducing apparatus. FIG. 2B is a left-hand side view showing the accommodated state of the sound-reproducing portion. FIG. 3A is a top plan view showing the accommodated state of the sound-reproducing portion. FIG. 3B is a bottom plan view showing the accommodated state of the sound-reproducing portion.

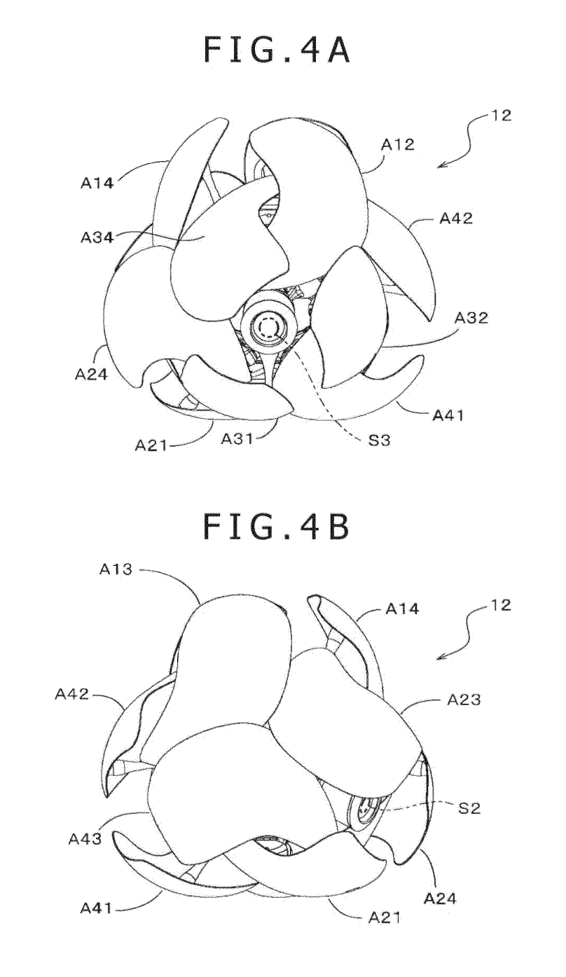

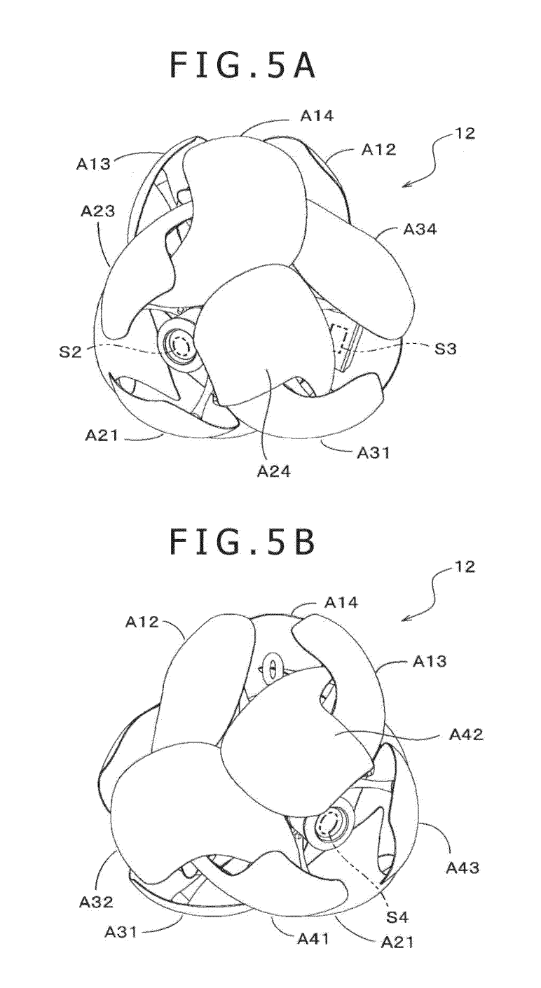

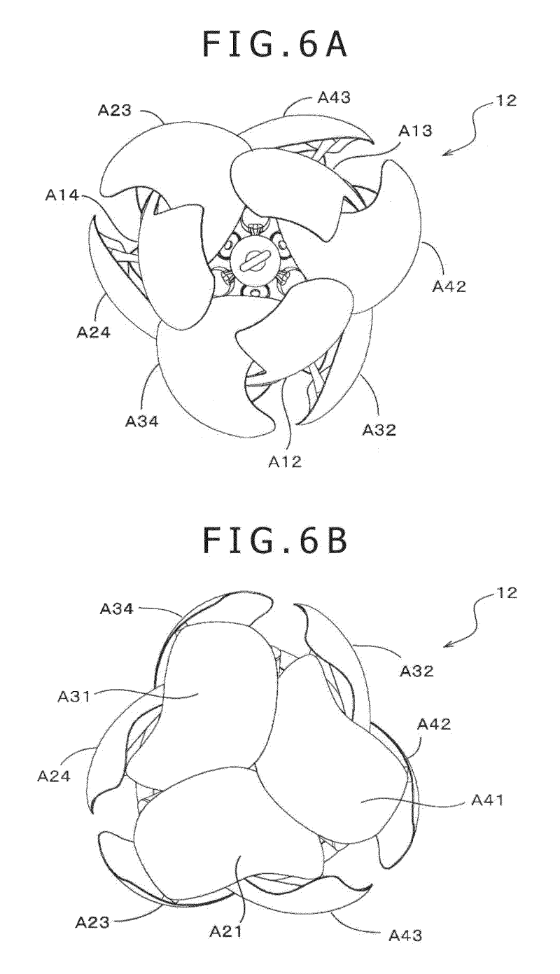

FIG. 4A is a front view showing an expanded state of the sound-reproducing portion. FIG. 4B is a rear view showing the expanded state of the sound-reproducing portion. FIG. 5A is a right-hand side view showing the expanded state of the sound-reproducing portion. FIG. 5B is a left-hand side view showing the expanded state of the sound-reproducing portion. FIG. 6A is a top plan view showing the expanded state of the sound-reproducing portion. FIG. 6B is a bottom plan view showing the expanded state of the sound-reproducing portion.

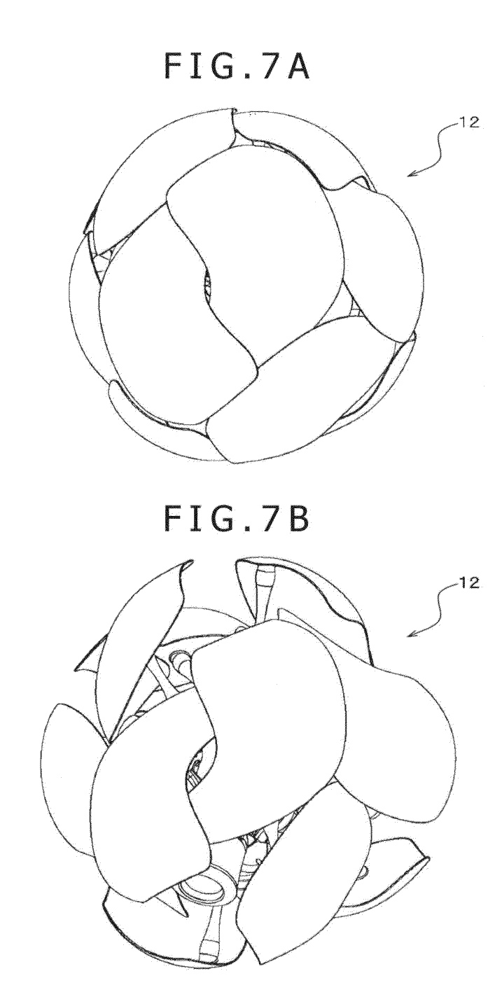

FIG. 7A is a perspective view showing the accommodated state of the sound-reproducing portion. FIG. 7B is a perspective view showing the expanded state of the sound-reproducing portion.

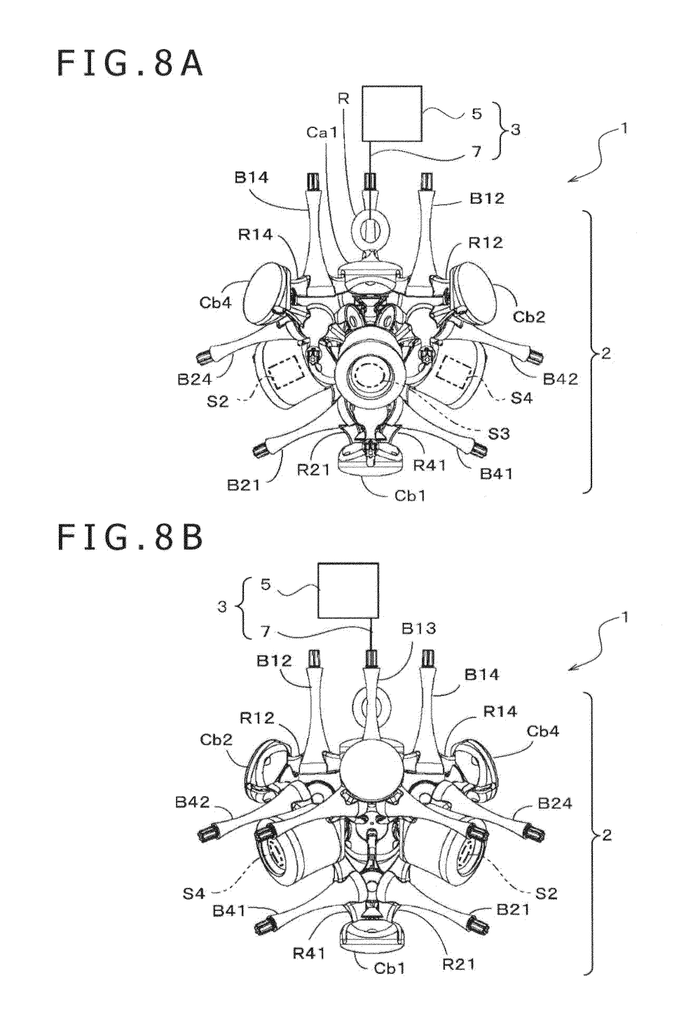

FIG. 8A is a front view showing the accommodated state of a suspended opening and closing apparatus included in the sound-reproducing apparatus according to the first embodiment of the present disclosure. FIG. 8B is a rear view showing the accommodated state of the suspended opening and closing apparatus.

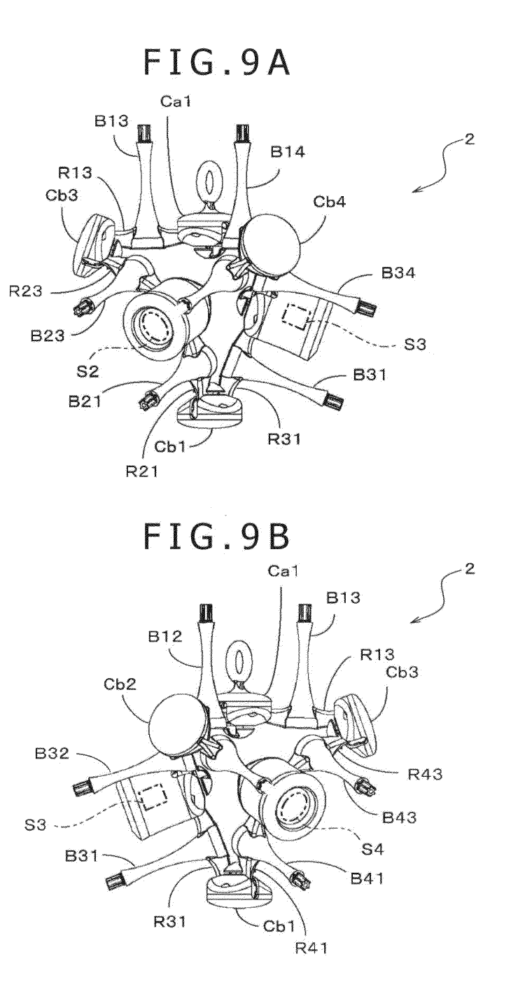

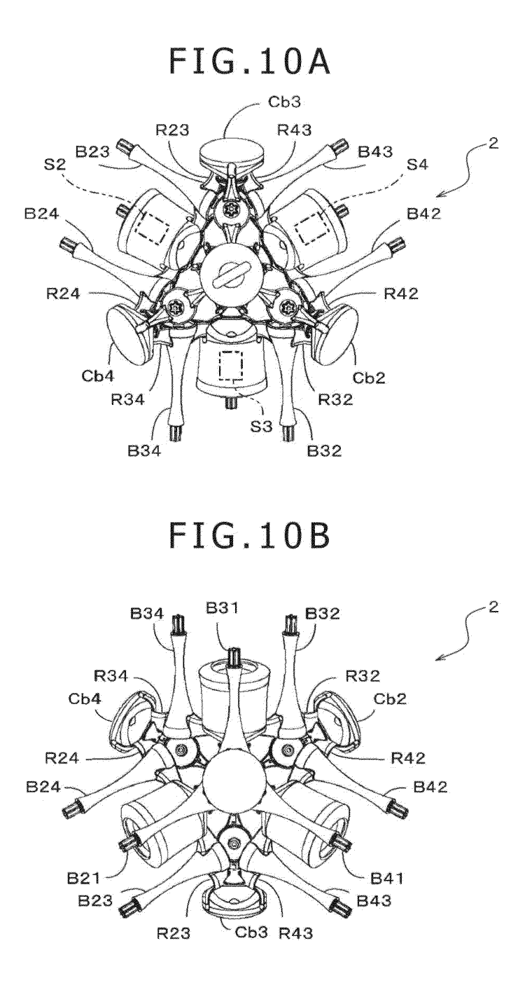

FIG. 9A is a right-hand side view showing the accommodated state of the support structure. FIG. 9B is a left-hand side view showing the accommodated state of the support structure. FIG. 10A is a top plan view showing the accommodated state of the support structure. FIG. 10B is a bottom plan view showing the accommodated state of the support structure.

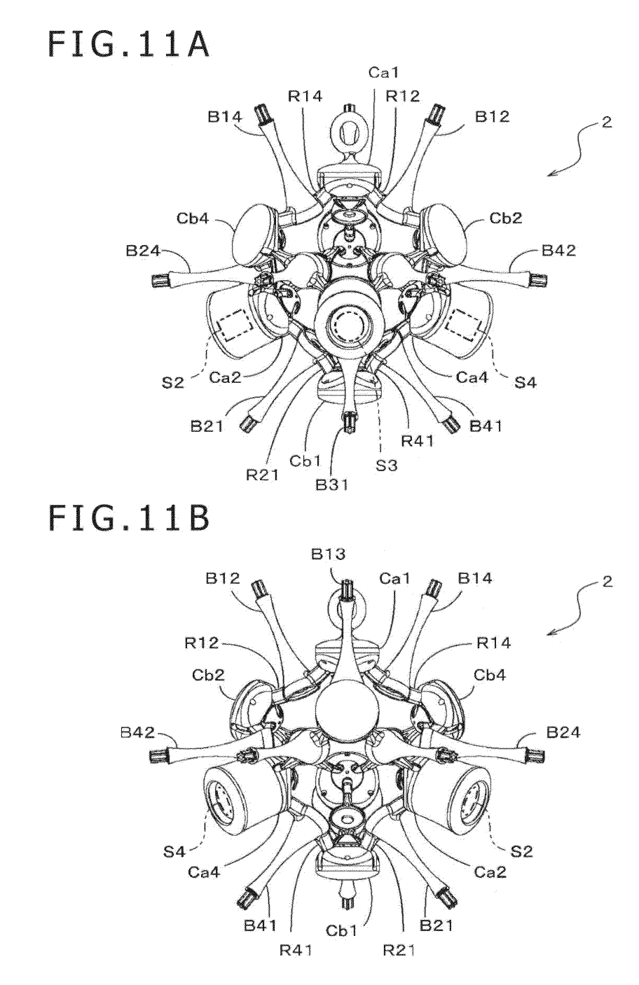

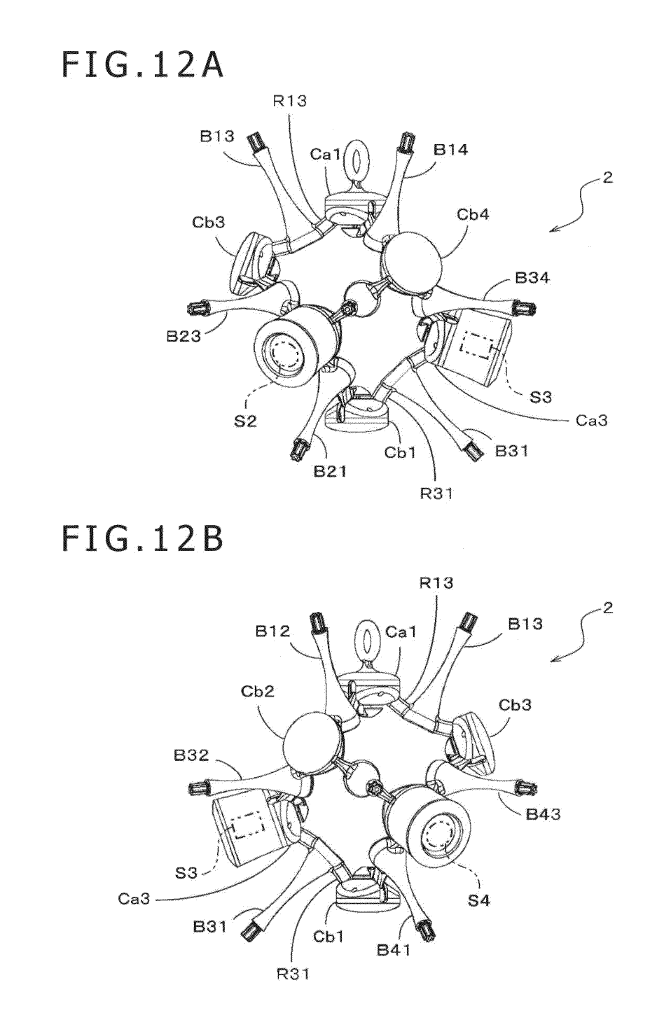

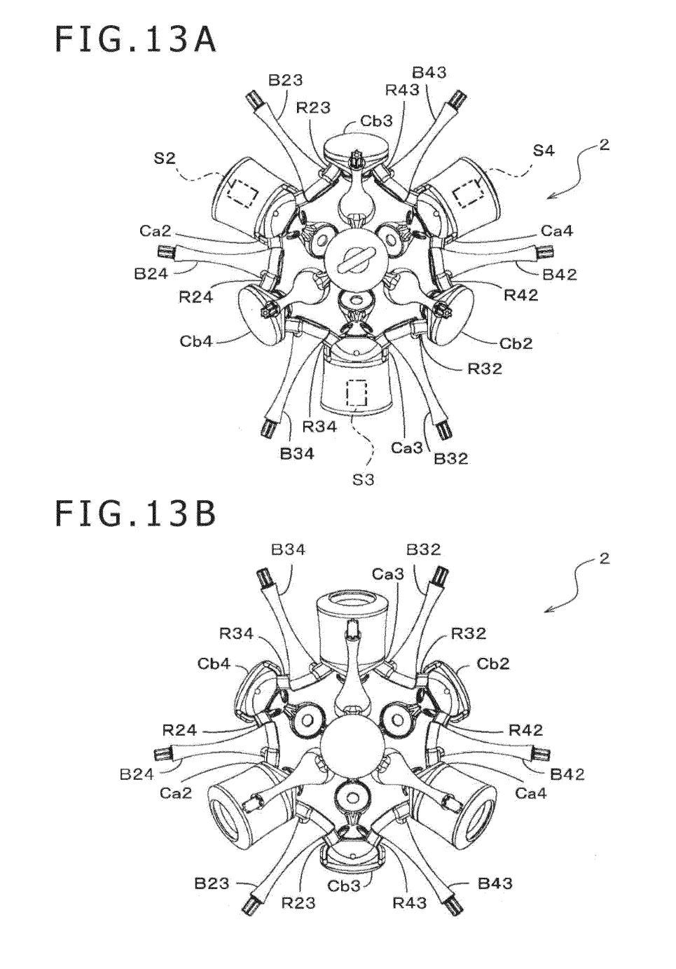

FIG. 11A is a front view showing an expanded state of the support structure. FIG. 11B is a rear view showing the expanded state of the support structure. FIG. 12A is a right-hand side view showing the expanded state of the support structure. FIG. 12B is a left-hand side view showing the expanded state of the support structure. FIG. 13A is a top plan view showing the expanded state of the support structure. FIG. 13B is a bottom plan view showing the expanded state of the support structure.

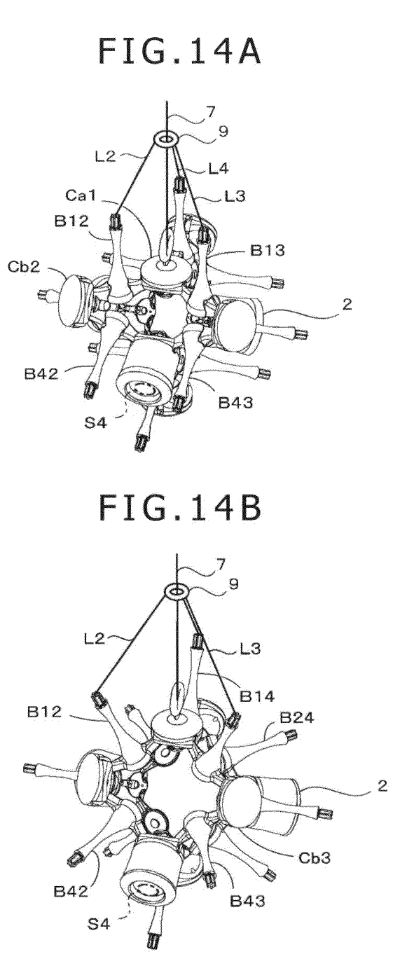

FIG. 14A is a perspective view showing the accommodated state of the support structure. FIG. 14B is a perspective view showing the expanded state of the support structure.

As shown in FIGS. 1A and 1B, the sound-reproducing apparatus 11 according to the first embodiment of the present disclosure is composed of an actuator 3, and the sound-reproducing portion 12 including plural panels.

The sound-reproducing portion 12 includes in the inside thereof the support structure 2 shown in FIGS. 8A and 8B to FIGS. 14A and 14B. As shown in FIGS. 8A and 8B, the suspended opening and closing apparatus 1 included in the sound-reproducing apparatus 11 according to the first embodiment is composed of the actuator 3, and the support structure 2.

The suspended opening and closing apparatus 1 has the accommodated state and the expanded state. Therefore, the sound-reproducing apparatus 11 including the support structure 2 inside also has the accommodated state and the expanded state.

The support structure 2 is composed of plural joint sites and plural rods. As will be described later, when two regular tetrahedra are supposed, the plural joint sites are disposed at positions corresponding to the vertices of the two regular tetrahedra, respectively.

As shown in FIGS. 8A and 8B to FIGS. 13A and 13B, speakers S2, S3, and S4 are respectively disposed on three of the joint sites. The speakers S2, S3, an S4 are respectively disposed on the joint sites placed at positions corresponding to three of the vertices of one regular tetrahedron. As shown in FIGS. 8A and 8B, the actuator 3 is coupled to the joint site at a position corresponding to the remaining vertex of the regular tetrahedron concerned.

As shown in FIGS. 8A and 8B to FIGS. 13A and 13B, each adjacent two joint sites are coupled to each other by a rod. From each of the rods, for example, a branch portion extends outward vertically to a direction connecting the coupled adjacent two joint sites. The plural panels, for example, are respectively joined to the branch portions that extend from the plural rods.

The joint sites, rods, panels, actuator 3, and speakers S2, S3, and S4 will now be described in order with reference to FIGS. 1A and 1B to FIGS. 16A and 16B.

### (Joint Sites and Rods)

As shown in FIGS. 8A and 8B to FIGS. 13A and 13B, the support structure 2 includes eight joint sites Ca1, Ca2, Ca3, Ca4, and Cb1, Cb2, Cb3, Cb4, and twelve rods R12, R13, R14, R23, R24, R21, R34, R31, R32, R41, R42, and R43.

The four joint sites Ca1, C4b, Ca3, and Ca4 are disposed at positions corresponding to four vertices of an assumed regular tetrahedron. Hereinafter, let a regular tetrahedron Ta be the regular tetrahedron obtained by connecting the joint sites Ca1, Ca2, Ca3, and Ca4. For example, the joint site Ca1 is disposed at a position corresponding to the top vertex of the regular tetrahedron Ta.

In addition, the four joint sites Cb1, Cb2, Cb3, and Cb4 are disposed at four positions corresponding to vertices of another assumed regular tetrahedron. Hereinafter, let a regular tetrahedron Tb be the regular tetrahedron obtained by connecting the joint sites Cb1, Cb2, Cb3, and Cb4.

The regular tetrahedron Ta shows a duality relation with the regular tetrahedron Tb. For example, in the accommodated state, the four vertices of the regular tetrahedron Ta are located at the positions of the internal centers of four the surfaces composing the regular tetrahedron Tb, respectively.

As shown in FIGS. 8A and 8B to FIGS. 13A and 13B, each of the eight joint sites Ca1, Ca2, Ca3, Ca4, and Cb1, Cb2, Cb3, Cb4 are coupled to three of the joint sites other than itself through three rods.

That is to say, the joint site Ca1 and the joint site Cb2 are coupled to each other by the rod R12, the joint site Ca1 and the joint site Cb3 are coupled to each other by the rod R13, and the joint site Ca1 and the joint site Cb4 are coupled to each other by the rod R14. The joint site Ca2 and the joint site Cb3 are coupled to each other by the rod R23, the joint site Ca2 and the joint site Cb4 are coupled to each other by the rod R24, and the joint site Ca2 and the joint site Cb1 are coupled to each other by the rod R21. The joint site Ca3 and the joint site Cb4 are coupled to each other by the rod R34, the joint site Ca3 and the joint site Cb1 are coupled to each other by the rod R31, and the joint site Ca3 and the joint site Cb2 are coupled to each other by the rod R32. Further, the joint site Ca4 and the joint site Cb1 are coupled to each other by the rod R41, the joint site Ca4 and the joint site Cb2 are coupled to each other by the rod R42, and the joint site Ca4 and the joint site Cb3 are coupled to each other by the rod R43.

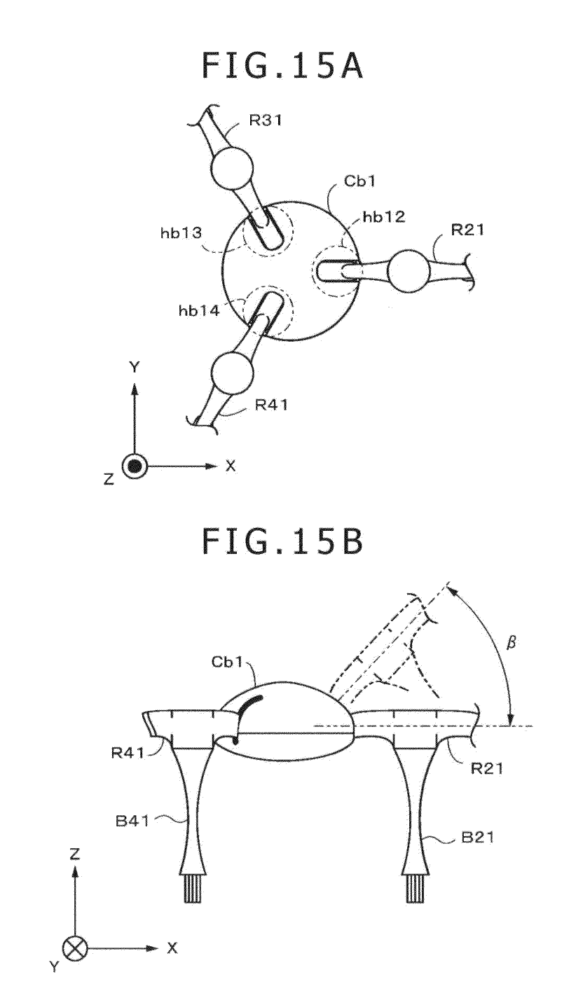

FIG. 15A is a schematic view showing one of the plural joint sites when viewed from the center of the support structure 2. FIG. 15A shows the joint site Cb1, located in the bottommost portion of the eight joint sites, and also part of the rods R21, R31, and R41 coupled to the joint site Cb1 are illustrated.

As shown in FIG. 15A, for example, the joint site Cb1 is provided with hinges hb12, hb13, and hb14. The rods R21, R31, and R41 are coupled to the joint site Cb1 by the hinges hb12, hb13, and hb14, respectively. Note that, when a direction from the joint site Cb1 to the joint site Ca1 is taken as the Z-axis direction, and a plane vertical to the Z-axis direction is taken as the XY-plane, projections of the rods R21, R31, and R41 on the XY-plane have an angle of (2π/3) [rad] (120° in degree measure) between each other.

Likewise, the other joint sites each has three hinges, and each joint site is coupled to other joint sites by rods via the three hinges.

FIG. 15B is a schematic view illustrating a movable range of the rods with respect to a joint site. FIG. 15B corresponds to a view where the joint site Cb1 shown in FIG. 15A is viewed in the Y-axis direction.

The rods and the joint sites are, for example, coupled to each other in a rotatable manner by the hinges or the like. For example, the rod R21 can rotate with respect to the joint site Cb1 from the XY-plane toward the Z-axis direction within the range of β=Arctan(2 ^{1/2}) [rad] (about 54.74° in degree measure).

For example, as shown in FIGS. 8A and 8B to FIGS. 13A and 13B and FIG. 15B, the rods R12, R13, R14, R23, R24, R21, R34, R31, R32, R41, R42, and R43 have branch portions extending in directions vertical to the directions in which those rods extend, respectively. For example, as shown in FIG. 15B, the rod R21 has the branch portion B21 extending toward the outside of the support structure 2.

Likewise, the rod R13 has the branch portion B13, and the rod R14 has the branch portion B14. The rod R23 has the branch portion B23, the rod R24 has the branch portion B24, and the rod R21 has the branch portion B21. The rod R34 has the branch portion B34, the rod R31 has the branch portion B31, and the rod R32 has the branch portion B32. The rod R41 has the branch portion B41, the rod R42 has the branch portion B42, and the rod R43 has the branch portion B43.

Panels which will be described later are attached respectively to the plural branch portions.

Examples of materials composing the joint sites and the rods are a resin material, a metal material, a sintered material such as ceramics, but their materials are not particularly limited.

Methods of processing these materials are also not particularly limited, and mold injection or a mechanical working such as a press working or the like may be applied.

Alternatively, a rapid prototyping technology may be applied to the manufacturing of the joint sites or the rods. The rapid prototyping technology means a 3D (three-dimensional) modeling technology with which trial products can be speedily obtained. In recent years, not only trial products but also components and finished products are produced applying the rapid prototyping technology.

Methods applicable to the rapid prototyping technology include an optical modeling method, a powder sintering method, fused deposition modeling, an inkjet method, and a sheet lamination method. The optical modeling method is a method in which an ultraviolet laser beam is radiated to a resin material making radical polymerization or cation polymerization to selectively cure the resin material, thereby modeling a cubic object. Using the optical modeling method, it is possible to obtain a high-definition component or finished product having high permeability. The powder sintering method is a method in which a laser beam or the like is radiated on raw material powder laid in lamination to directly sinter the raw material powder or to selectively add a binder thereto by utilizing the inkjet system, so that the raw material powder is solidified to model a cubic object. Application of the powder sintering method also makes it possible to employ such a material as a metallic material having high durability.

By applying the rapid prototyping technology, for example, even a person who has less knowledge or experience on mechanical working can manufacture automatically a member having a complicated stereoscopic shape even including an internal shape in one process. In addition, since it is unnecessary to use a mold or the like, it is possible to suppress the manufacturing costs of the joint sites or rods.

### (Panels)

As shown in FIGS. 1A and 1B to FIGS. 6A and 6B, the sound-reproducing portion 12, for example, has twelve panels A12, A13, A14, A23, A24, A21, A34, A31, A32, A41, A42, and A43. The panels A12, A13, A14, A23, A24, P21, A34, A31, A32, A41, A42, and A43 are joined to the branch portions B12, B13, B14, B23, B24, B21, B34, B31, B32, B41, B42, and B43 provided to the individual rods, respectively.

As shown in FIGS. 1A and 1B to FIGS. 6A and 6B, for example, the plural panels generally have the same shape. The panels function as sound reflectors for output sounds from the speakers S2, S3, and S4 which will be described later.

Since the panels are respectively joined to the branch portions provided on the individual rods, their positions and angles change depending on whether the support structure 2 is in the accommodated state or the expanded state. That is to say, when the support structure 2 is in the accommodated state, the sound-reproducing apparatus 11 takes the accommodated state accordingly. On the other hand, when the support structure 2 is in the expanded state, the sound-reproducing apparatus 11 takes the expanded state accordingly.

FIGS. 1A and 1B to FIGS. 6A and 6B show an example of the configuration in which the panels overlap with one another when the sound-reproducing apparatus 11 is in the accommodated state. It is not to mention that the shapes of the panels shown in FIGS. 1A and 1B to FIGS. 6A and 6B are merely examples and a manufacturer of the sound-reproducing apparatus 11 can suitably change the shapes of the panels.

Here, one example of a method for designing the panels will be described.

As described above, the sound-reproducing apparatus 11 has the two states of the accommodated state and the expanded state. Accordingly, the panels are required not to interfere with one another before and after the shift between the two states of the accommodated state and the expanded state.

When the shapes of the panels are simple, for example, each panel shape may be analyzed by a trial and error approach. However, since it is liable that the manufacturing costs become too high, designing by way of trial and error is impractical. In addition, the presence of requests for fabricating panels having a more elaborate and complicated design is well expected.

A method called “algorithmic design” is known as a design method that can be applied to such cases. The algorithmic design is a method which uses algorithm for solving a problem, and a form or structure is produced as the resolution thereof.

Algorithm means “a described procedure for accomplishing a certain purpose,” and it does not have a specific expression form. In algorithm design, for example, there is applied optimization, a cellular automaton, a multi-agent system, genetic algorithm, a neural network, chaos, a fractal, self-organization, diffusion-limited aggregation (DLA), generative grammar, artificial intelligence (AI), entropy, etc.

In recent years, visualized easy-to-use software for carrying out algorithmic design has also begun to be provided. For example, a designer of a product, building, or plant may use such software to produce a new design by utilizing a generative algorithm.

With the algorithmic design technique, for example, a designer of a product, building, or plant may also create a novel form or structure using a form existing in the natural world as a motif. As described above, algorithm means “a described procedure for accomplishing a certain purpose.” Therefore, a form obtained by algorithmic design will have an orderliness generated from some sort of a rule or rules. One example of the orderliness produced from some sort of a rule or rules is self-similarity.

For example, algorithmic design is applied to the designing of individual panel shapes in the following manner.

First, a spherical surface subsuming the support structure 2 in the accommodated state is supposed, and shapes obtained by dividing the spherical surface are used as the initial shapes of the individual panels. Next, for example, the initial shapes of the individual panels are converted into meshes, so as to treat each panel as a set of elements (small areas). Then, loci of the elements are changed between the two states of the accommodated state and the expanded state, and portions interfering with one another are analyzed on the software. Changing the initial shapes of the individual panels, the above analysis is repeated. When a resolution (shapes) is obtained, with which panels do not interfere with one another before and after shifting between the two states of the accommodated state and the expanded state, the analysis is ended and the shapes of the individual panels are determined.

Examples of a material composing the panels are a resin material, metal material, sintered material such as ceramics, mineral, glass, paper, cloth, vegetative material and a composite material thereof. However, the material is not particularly limited to those. It suffices if the selected material composing the panels meets the sound characteristics which the manufacturer desires, and for example, each of the panels may also be made of a material having flexibility. When a flexible material is selected as the material composing the panels, the panels can be curved during the shift between the accommodated state and the expanded state of the support structure 2, thereby giving a change in the shapes of the panels.

For example, a sound absorbing material may be disposed on part or all of the panels. In addition, one or more sound reflectors may also be disposed on either part or all of the panels.

A method for processing the material composing the panels is not particularly limited, and mechanical working or any other appropriate method may be applied. When the material is a resin material, injection molding or the like may as well be applied. Alternatively, for example, when the rapid prototyping technology is applied, the sound-reproducing apparatus 11 including panels having complicated shapes can be manufactured made-to-order in a short period of time.

### (Actuator)

As shown in FIGS. 1A and 1B and FIGS. 8A and 8B, the suspended opening and closing apparatus 1 and the sound-reproducing apparatus 11, for example, include an actuator 3 composed of a lifting motor 5 and a wire 7. The wire 7, for example, is coupled to a ring portion R provided above the joint site Ca1 of the suspended opening and closing apparatus 1.

The actuator 3 is a drive unit for shifting the suspended opening and closing apparatus 1 and the sound-reproducing apparatus 11 between the accommodated state and the expanded stare.

As an alternative to the set of the lifting motor 5 and wire 7, the actuator 3 may be configured by a linear actuator including a cylinder, cam, ball screw or the like; a so-called linear motor utilizing magnetic force; or electroactive polymer artificial muscle (EPAM) using either an organic material or an inorganic material. Examples of an organic material used in EPAM are a polymer gel, ion conductive polymer, conductive polymer, and so forth. An example of an inorganic material used in EPAM is a shape memory alloy.

The suspended opening and closing apparatus 1, as shown in FIGS. 14A and 14B, for example, is supported from above by wires L2, L3, and L4 connected to the branch portions B12, B13, and B14, respectively. FIGS. 14A and 14B show the case where the wires L2, L3, and L4 have a generally equal length and are connected to the ring 9 disposed above the joint site Ca1. The ring 9 may be held by being directly or indirectly coupled to a support member on a ceiling or a floor light. The wire 7, for example, is passed through the central portion of the ring 9.

Now, it is assumed that the suspended opening and closing apparatus 1 is in the accommodated state. The actuator 3 at this time is in an expanded state, and the joint site Ca1 is located at a position corresponding approximately to the internal center of the equilateral triangle obtained by connecting the joint sites Cb2, Cb3, and Cb4.

Next, when the lifting motor 5 lifts the wire 7, the joint site Ca1 will be drawn upward, and the motion of the joint site Ca1 is transmitted to the other joint sites through the rods. Along with the movement of the joint site Ca1, the joint sites Cb1, Cb2, Cb3, and Cb4 are moved toward the inside of the suspended opening and closing apparatus 1 while the joint sites Ca2, Ca3, and Ca4 are moved toward the outside of the suspended opening and closing apparatus 1.

The movement of the joint sites, for example, is continued until they reach positions where the forces applied to the respective portions of the suspended opening and closing apparatus 1 are balanced. The state at which the movement of the joint sites ends is the expanded state of the suspended opening and closing apparatus 1 and the sound-reproducing apparatus 11. Incidentally, when the individual rods can smoothly move at the joint sites, a large force is not required for the lifting of the wire 7.

Incidentally, the shift from the expanded state to the accommodated state is readily carried out by releasing the lifting of the wire 7.

### (Speakers)

As shown in FIGS. 8A and 8B to FIGS. 13A and 13B, the sound-reproducing apparatus 11 includes the three speakers S2, S3, and S4. Input to the three speakers S2, S3, and S4, for example, are done through one channel, and audio or music is reproduced by way of electroacoustic conversion in the three speakers S2, S3, and S4.

The kind of three speakers S2, S3, and S4 is not especially limited. For example, it is possible to employ a corn type speaker, a dome type speaker, a horn type speaker, a ribbon type speaker, an electrostatic type speaker or the like.

As shown in FIGS. 8A and 8B to FIGS. 13A and 13B, the speakers S2, S3, and S4 are respectively disposed on the three joint sites excluding the joint site Ca1, namely, the joint sites Ca2, Ca3, and Ca4. Therefore, when the state of the sound-reproducing apparatus 11 is changed from the accommodated state to the expanded state, along with the movement of the joint sites Ca2, Ca3, and Ca4, the speakers S2, S3, and S4 appear from spaces between the panels.

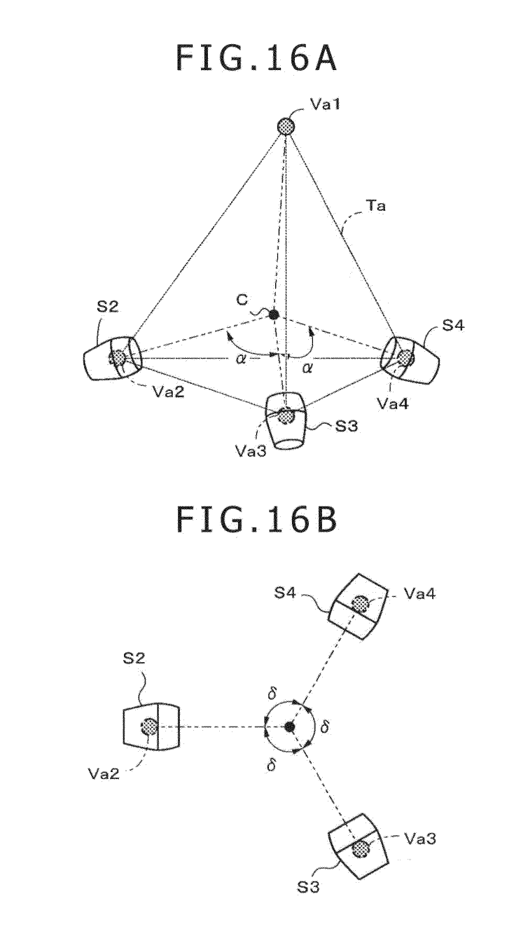

FIGS. 16A and 16B are schematic line diagrams explaining the arrangement of the three speakers. In FIGS. 16A and 16B, vertices Va1, Va2, Va3, and Va4 of the regular tetrahedron Ta are represented by shaded circles. In addition, the center of gravity of the regular tetrahedron Ta is represented by a black circle C.

As shown in FIG. 16A, the three positions where the three speakers S2, S3, and S4 are disposed respectively correspond to the three vertices Va2, Va3, and Va4 of the regular tetrahedron Ta. Here, an angle α between each two adjacent lines of the lines connecting the center of gravity C with the three vertices Va2, Va3, and Va4 of the regular tetrahedron Ta is Arccos(−⅓) [rad] (about 109.47° in degree measure).

It is noted that the relationships among the vertices Va1, Va2, Va3, and Va4 of the regular tetrahedron Ta is reserved before and after the shift between the two states of the accommodated state and the expanded state of the sound-reproducing apparatus 11. In other words, a regular tetrahedron obtained by connecting the vertices Va1, Va2, Va3, and Va4 with one another in the accommodated state, and a regular tetrahedron obtained by connecting the vertices Va1, Va2, Va3, and Va4 with one another in the expanded state are similar to each other. Therefore, the angle α does not change before and after the shift between the two states of the accommodated state and the expanded state.

FIG. 16B corresponds to a view showing the projections of the vertices Va2, Va3, and Va4, and the center of gravity C on the bottom surface of the regular tetrahedron Ta. As sown in FIG. 16B, an angle δ formed between each adjacent two of the three speakers S2, S3, and S4 is 2π/3 [rad] (120° in degree measure). Therefore, when the spreading of the sound reproduced from the individual speakers S2, S3, and S4 is equivalent to or larger than 2π/3 [rad], it can be said that the directionality of the sound-reproducing apparatus 11 is approximately omnidirectional.

As described above, in the expanded state, the speakers S2, S3, and S4 are exposed via spaces between the panels. Accordingly, for example, when the sound-reproducing apparatus 11 whose directionality is approximately omnidirectional is suspended from the ceiling, and music is reproduced by the sound-reproducing apparatus 11 in the expanded state, a user of the sound-reproducing apparatus 11 can obtain such an effect that the user is showered with music.

### [Expanding Mechanism]

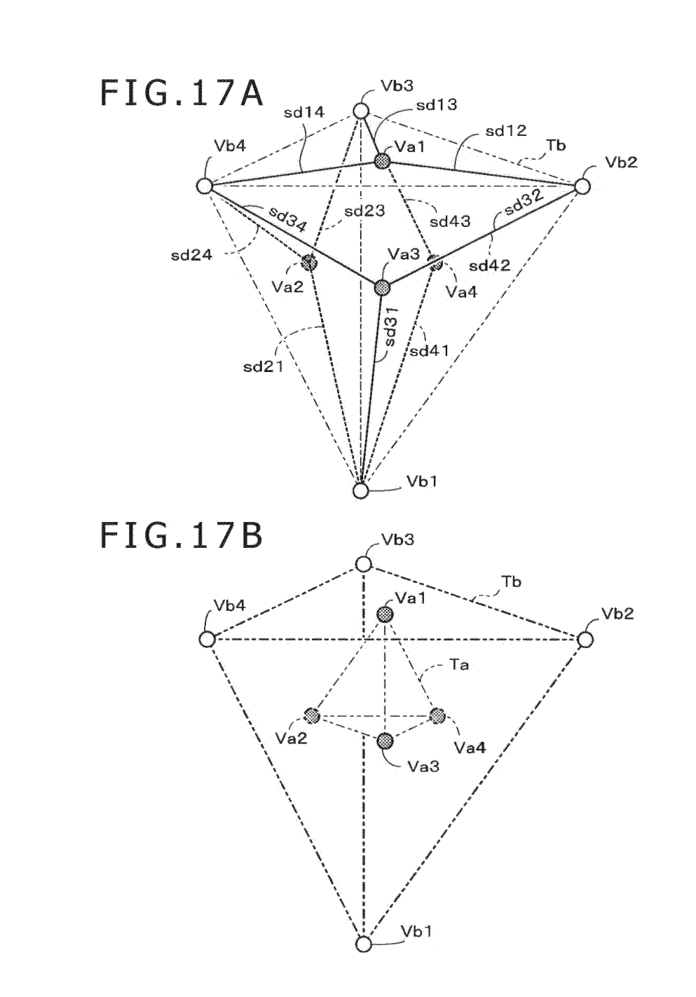

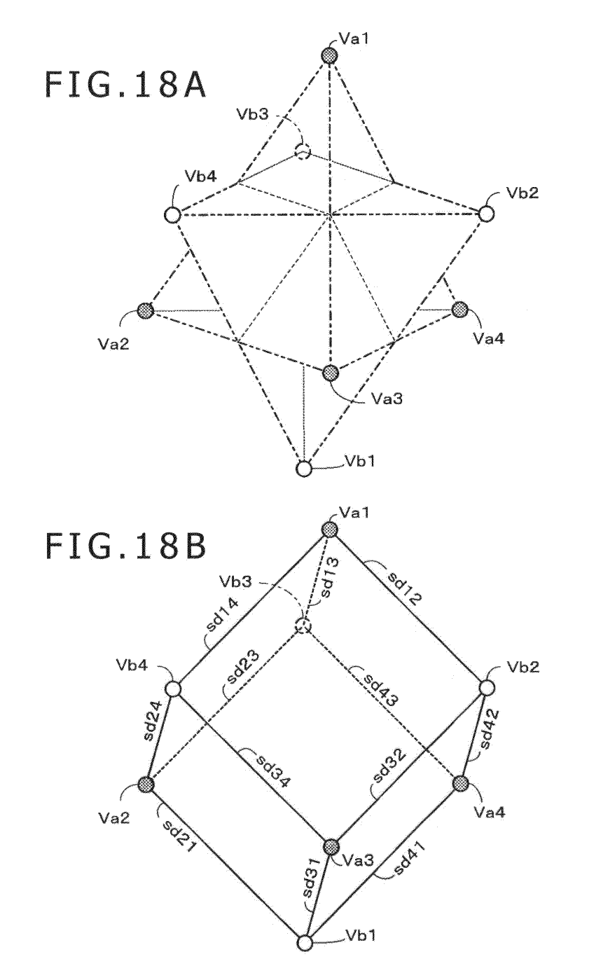

Next, an expanding mechanism for shifting the suspended opening and closing apparatus 1 and the sound-reproducing apparatus 11 mutually between the accommodated state and the expanded state will be described with reference to FIGS. 17A and 17B, and FIGS. 18A and 18B.

FIGS. 17A and 17B are schematic line diagrams explaining the arrangement of the joint sites and the rods in the accommodated state. It is noted that in FIGS. 17A and 17B, the vertices Va1, Va2, Va3, and Va4 of the regular tetrahedron Ta are represented by shaded circles, and the vertices Vb1, Vb2, Vb3, and Vb4 of the regular tetrahedron Tb are represented by open circles.

As described above, in the accommodated state, the joint sites Ca1, Ca2, Ca3, and Ca4 of the support structure 2 are located at positions corresponding to the vertices Va1, Va2, Va3, and Va4 of the regular tetrahedron Ta, respectively. In addition, the joint sites Cb1, Cb2, Cb3, and Cb4 of the support structure 2 are located at positions corresponding to the vertices Vb1, Vb2, Vb3, and Vb4 of the regular tetrahedron Tb, respectively.

Further, in the accommodated state, the regular tetrahedron Ta and the regular tetrahedron Tb are in a duality relation with each other. That is to say, as shown in FIG. 17B, the vertices Va1, Va2, Va3, and Va4 of the regular tetrahedron Ta are located at positions corresponding to the internal centers of the surfaces composing the regular tetrahedron Tb. For example, the vertix Va3 is located at a position corresponding to the internal center of the equilateral triangle obtained by connecting the vertices Vb4, Vb1, and Vb2.

Each line segment connecting one of the vertices Va1, Va2, Va3, and Va4 of the regular tetrahedron Ta with one of the vertices Vb1, Vb2, Vb3, and Vb4 of the regular tetrahedron Tb in FIG. 17A corresponds to the rod interposed between the corresponding adjacent two joint sites. For example, the line segments sd12, sd13, and sd14 correspond to the rods R12, R13, and R14, respectively. Likewise, the line segments sd23, sd24, and sd21 correspond to the rods R23, R24, and R21, respectively. The line segments sd34, sd31, and sd32 correspond to the rods R34, R31, and R32, respectively. The line segments sd41, sd42, and sd43 correspond to the rods R41, R42, and R43, respectively.

As described above, each of rods has a branch portion extending in a direction vertical to the direction in which the rod extends. Therefore, in the accommodated state, each of the branch portions extends in a direction vertical to the corresponding surface of the regular tetrahedron Tb and toward the outside of the regular tetrahedron Tb. Although not illustrated in FIGS. 17A and 17B, for example, the three branch portions B12, B13, and B14 extend in a direction vertical to the surface including the vertices Vb2, Vb3, and Vb4. The head portions of the three branch portions B12, B13, B14 are located within a surface parallel to that surface concerned.

Now, when one of the joint sites Ca1, Ca2, Ca3, and Ca4 is moved toward the outside of the regular tetrahedron Ta, as described above, the eight joint sites and the twelve rods will move synchronously with each other.

Following the motion of the vertices of this time, the vertices move toward the outside of the regular tetrahedron Ta while maintaining the angle between each adjacent two line segments connecting different vertices. On the other hand, the vertices Vb1, Vb2, Vb3, and 7b4 of the regular tetrahedron Tb move toward the inside of the regular tetrahedron Tb while the angle between each adjacent two line segments connecting different vertices is maintained. That is to say, the vertices Va1 to Va4 of the regular tetrahedron Ta and the vertices Vb1 to 7b4 of the regular tetrahedron Tb each move while maintaining the stereoscopic shape (regular tetrahedron) obtained by connecting the vertices.

The movement of the vertices of the regular tetrahedron Ta and the regular tetrahedron Tb continue until the state of the suspended opening and closing apparatus 1 or the sound-reproducing apparatus 11 reaches the expanded state.

FIGS. 18A and 18B are schematic views explaining the disposition of the joint sites and the rods in the expanded state.

As shown in FIG. 18A, the movement of the vertices of the regular tetrahedron Ta and the regular tetrahedron Tb continue until the regular tetrahedron obtained by connecting the vertices Va1, Va2, Va3, and Va4, and the regular tetrahedron obtained by connecting the vertices Vb1, Vb2, Vb3, and Vb4 become congruent to each other. That is to say, when the side of the two regular tetrahedra in the expanded state are illustrated, as shown in FIG. 18A, intersecting bodies of the two regular tetrahedra are obtained.

At this time, when the vertices of the regular tetrahedron Ta and the vertices of the regular tetrahedron Tb are connected to each other, as shown in FIG. 18B, a regular hexahedron is obtained. That is to say, the rods in the expanded state are disposed so as to correspond to the twelve sides of the regular hexahedron, respectively. Incidentally, the overlapping portion between the two regular tetrahedra described above forms a regular octahedron in a duality relation with the regular hexahedron described above.

In addition, although not illustrated in FIG. 18B, when the head portions of the branch portions are connected to one another, a cuboctahedron is obtained. Therefore, along with the shift of the sound-reproducing apparatus 11 from the accommodated state to the expanded state, the disposition of the panels joined to the head portions of the branch portions change such that the spaces between adjacent panels become large, as if they are billowing.

As described so far, according to the first embodiment of the present disclosure, with a very simple manipulation such as manipulating one wire, the mutual shift between the accommodated state and the expanded state can be carried out at will.

This results from the duality relation between the regular tetrahedron Ta and the regular tetrahedron Tb.

In the three-dimensional space, regular polyhedra are limited to five: a regular tetrahedron, regular hexahedron, regular octahedron, regular dodecahedron, and regular icosahedron. The regular hexahedron and regular octahedron are dual to each other. In addition, the regular dodecahedron and regular icosahedron are also dual to each other.

Here, of the five regular polyhedra described above, only the regular tetrahedron is self-dual.

The joint sites are disposed at positions corresponding to the vertices of the two regular tetrahedra which are in a duality relation with each other. Each adjacent two joint sites are coupled to each other, whereby such an effect is obtained that the entire external appearance is dramatically changed by only pulling one of the joint sites. Even if, for example, the joint sites are disposed at positions corresponding to the vertices of a hexahedron and an octahedron, and each adjacent two joint sites are coupled to each other, the joint sites will be locked and thus an effect as described above is difficult to obtain.

The sound-reproducing apparatus 11 according to the first embodiment of the present disclosure includes the three speakers S2, S3, and S4. The three positions where the speakers S2, S3, and S4 are disposed are positions corresponding to three vertices of the four vertices of one regular tetrahedron Ta. In addition, the rods that link the joint sites with one another are attached with the panels whose positions and angles in the whole change before and after the shift between the accommodated state and the expanded state along with the movement of the rods.

Therefore, according to the sound-reproducing apparatus 11 of the first embodiment of the present disclosure, different acoustic effects can be obtained by changing the state between the accommodated state and the expanded state. For example, when a user of the sound-reproducing apparatus is enjoying a meal with his or her family, the user can set the sound-reproducing apparatus 11 in the accommodated state to reproduce a back-ground music. On the other hand, for example, when the user invites his or her friends for a party, the user can set the sound-reproducing apparatus 11 in the expanded state to create a resplendent atmosphere.

In such a manner, the user of the sound-reproducing apparatus selects the state of the sound-reproducing apparatus 11 in accordance with the music to be reproduced or the atmosphere of the place, thereby obtaining the desired sound effect. In addition, if the user of the sound-reproducing apparatus changes the state between the accommodated state and the expanded state while reproducing music, it is also possible to obtain the effect of fade-in and fade-out without changing the sound volume of the speakers.

### 2. Second Embodiment

### [Outline of Configuration of Lighting Apparatus]

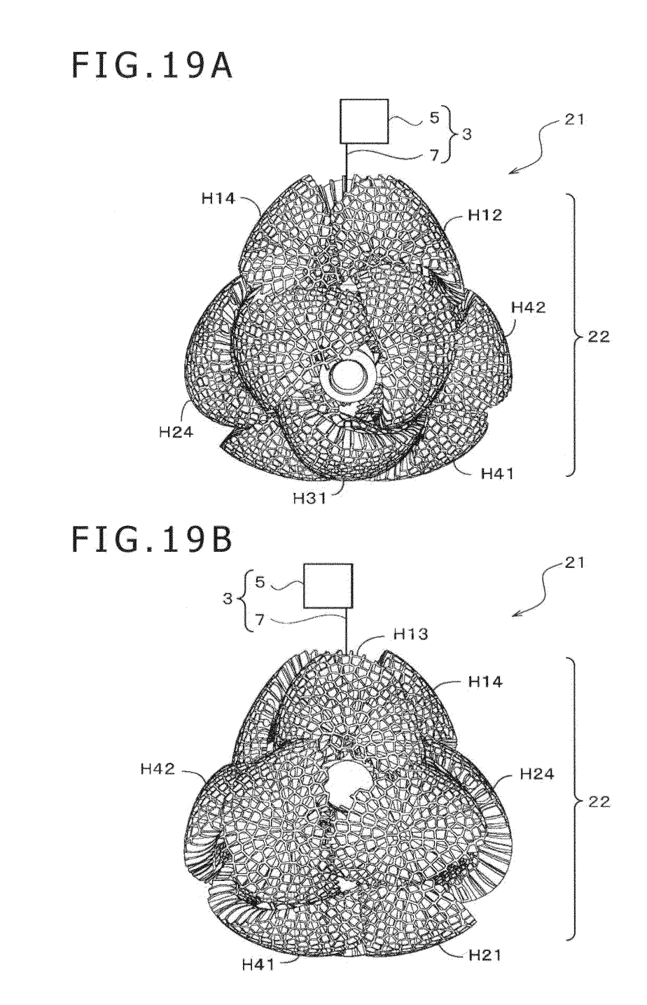

FIG. 19A is a front view showing an accommodated state of a lighting apparatus according to a second embodiment of the present disclosure. FIG. 19B is a rear view showing the accommodated state of the lighting apparatus according to the second embodiment of the present disclosure.

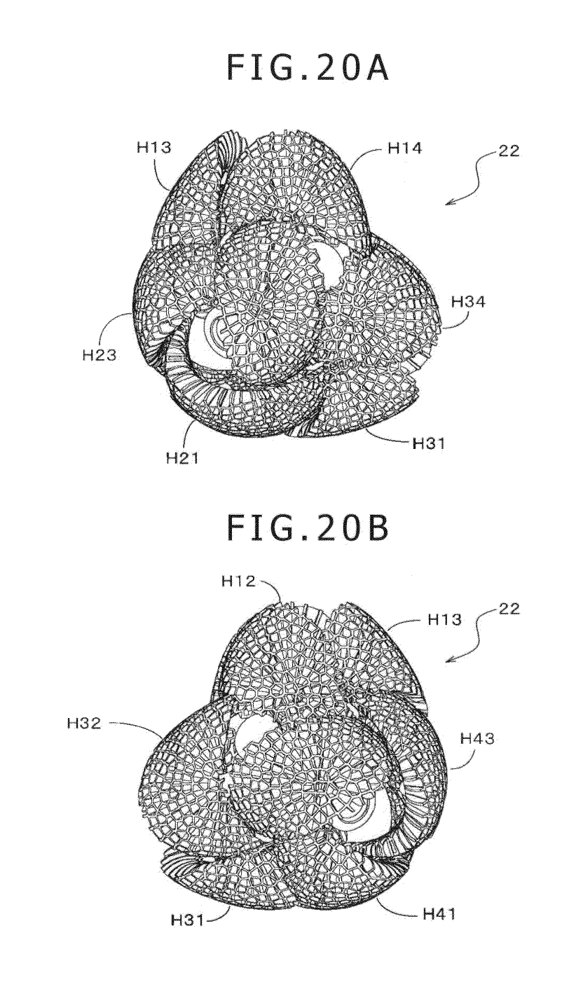

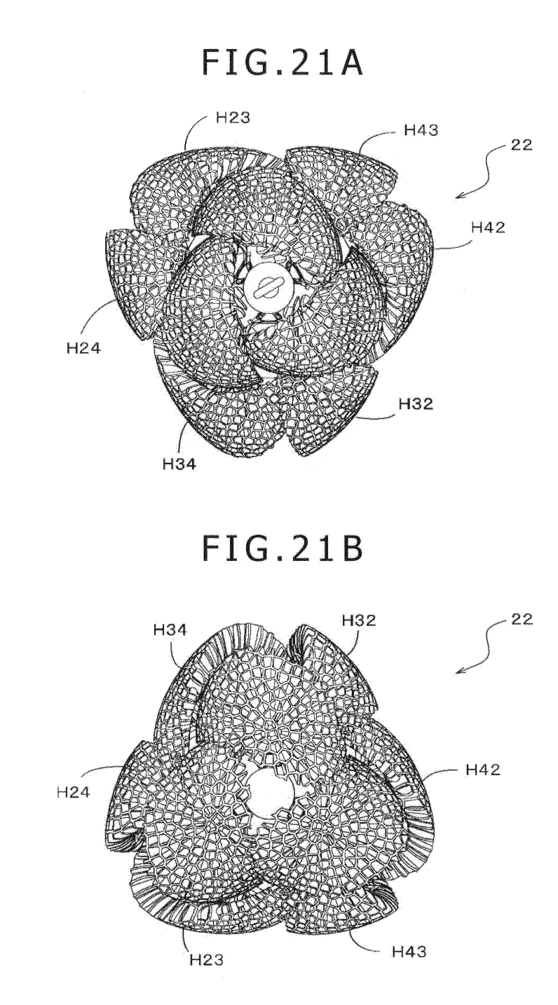

FIG. 20A is a right-hand side view showing an accommodated state of an illuminator included in the lighting apparatus. FIG. 20B is a left-hand side view showing the accommodated state of the illuminator. FIG. 21A is a top plan view showing the accommodated state of the illuminator. FIG. 21B is a bottom plan view showing the accommodated state of the illuminator.

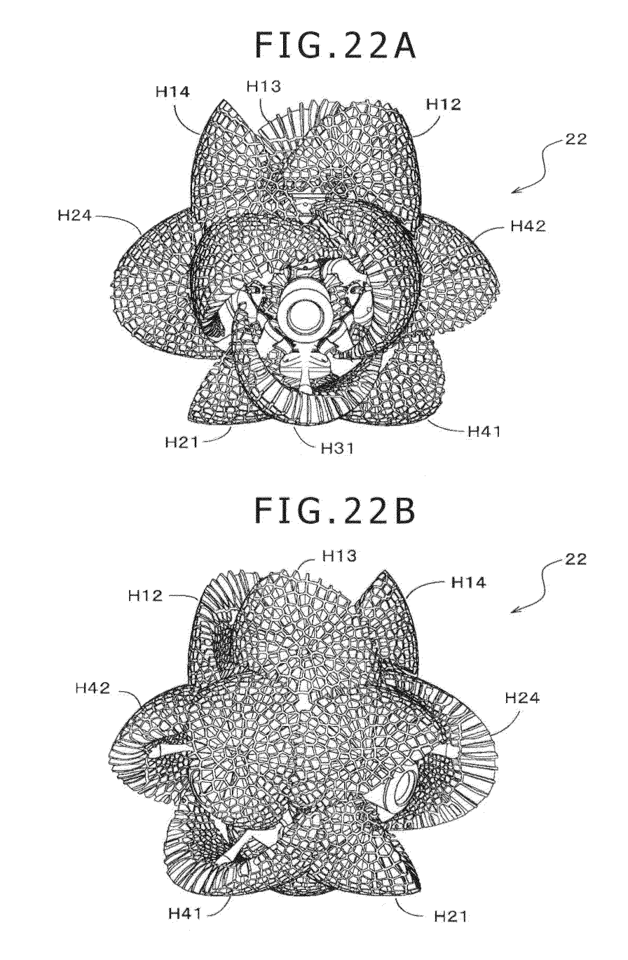

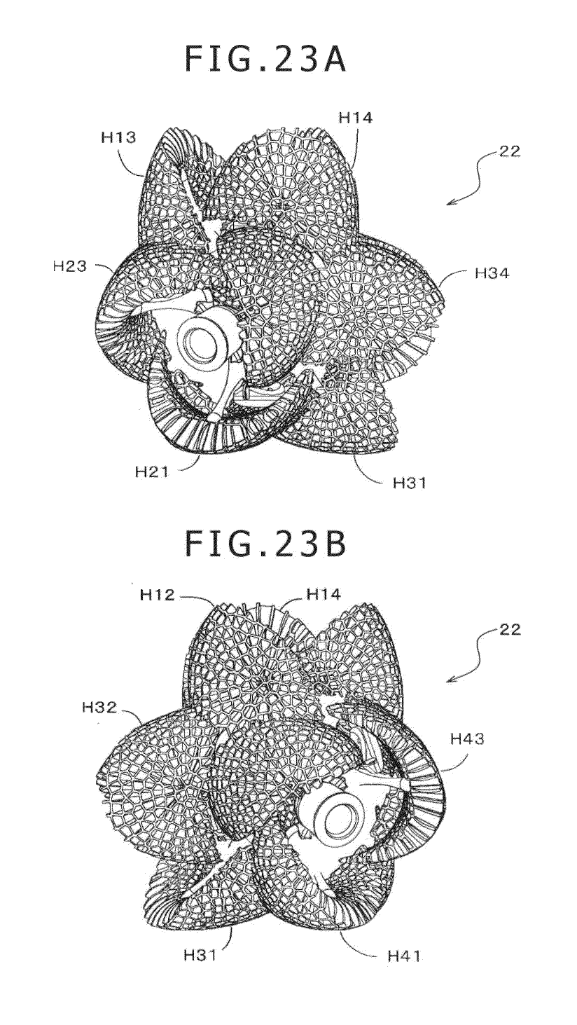

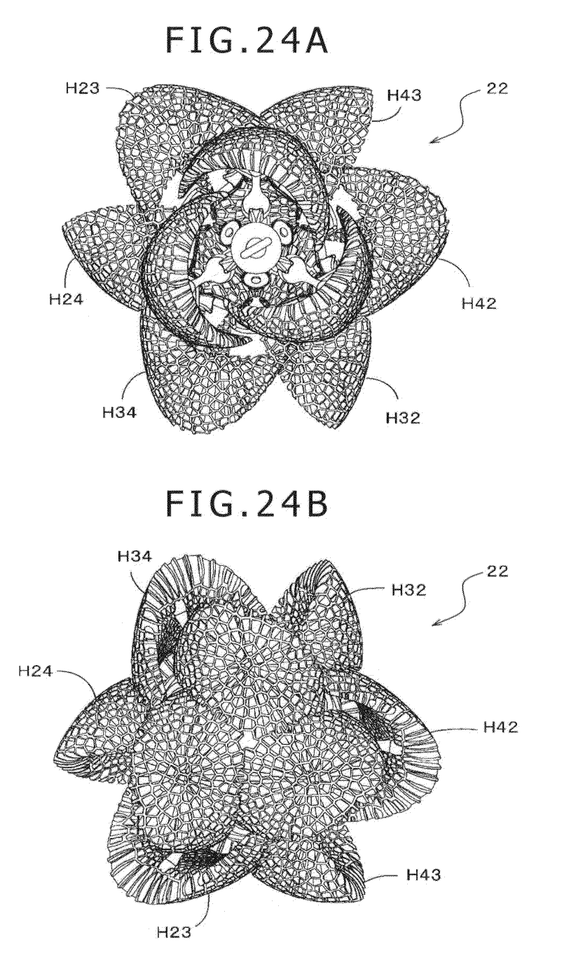

FIG. 22A is a front view showing an expanded state of the illuminator. FIG. 22B is a rear view showing the expanded state of the illuminator. FIG. 23A is a right-hand side view showing the expanded state of the illuminator. FIG. 23B is a left-hand side view showing the expanded state of the illuminator. FIG. 24A is a top plan view showing the expanded state of the illuminator. FIG. 24B is a bottom plan view showing the expanded state of the illuminator.

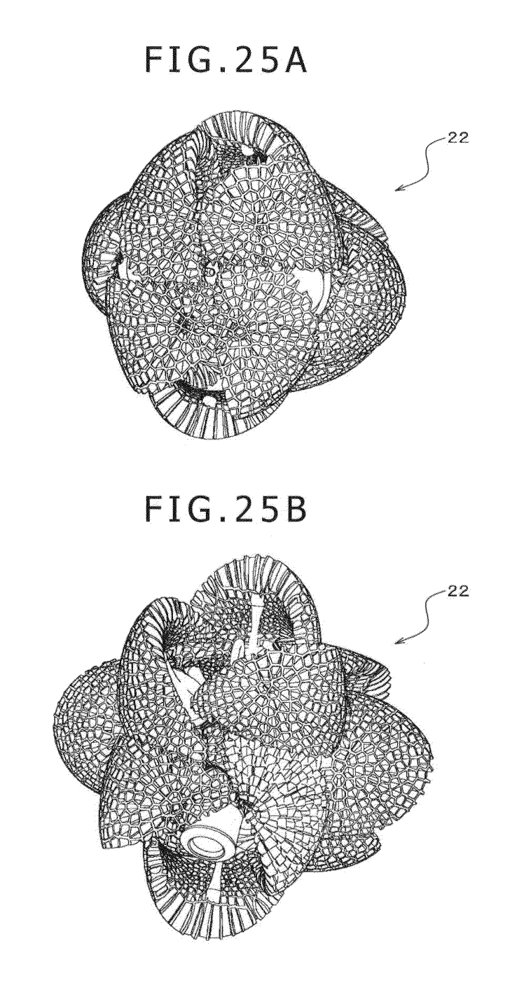

FIG. 25A is a perspective view showing the accommodated state of the illuminator. FIG. 25B is a perspective view showing the expanded state of the illuminator.

As shown in FIGS. 19A and 19B, the lighting apparatus 21 according to the second embodiment of the present disclosure is composed of an actuator 3, an the illuminator 22 including plural panels.

The illuminator 22 is identical with the sound-reproducing apparatus 11 of the first embodiment in that the illuminator 22 includes, in the inside thereof, the support structure composed of plural joint sites, disposed at positions corresponding to vertices of two regular tetrahedra in a duality relation with each other, and plural rods coupling the plural joint sites with one another. Therefore, the lighting apparatus 21 including the support structure having the accommodated state and the expanded state as well has the accommodated state and the expanded state. It is noted that the panels are joined to the rods, respectively, similarly to the case of the first embodiment.

The lighting apparatus 21 of the second embodiment is different from the sound-reproducing apparatus 11 of the first embodiment in that speakers are not disposed on three joint sites. In addition, the lighting apparatus 21 is different in that plural light emitting portions are disposed on at least part of the joint sites or the rods, selected from a set of plural joint sites and plural rods so as to have symmetry.

The plural light emitting portions, for example, are disposed on a side opposite to the branch portion provided on the individual rod with respect to the direction in which the rod extends. In this case, light beams emitted from the plural light emitting portions travel toward the center of the illuminator 22 to be emitted toward the outside of the illuminator 22 through panels or a space between the panels.

The joint sites, the rods, the light emitting portions, and the panels will now be described in order with reference to FIGS. 19A and 19B to FIGS. 27A and 27D.

### (Joint Sites and Rods)

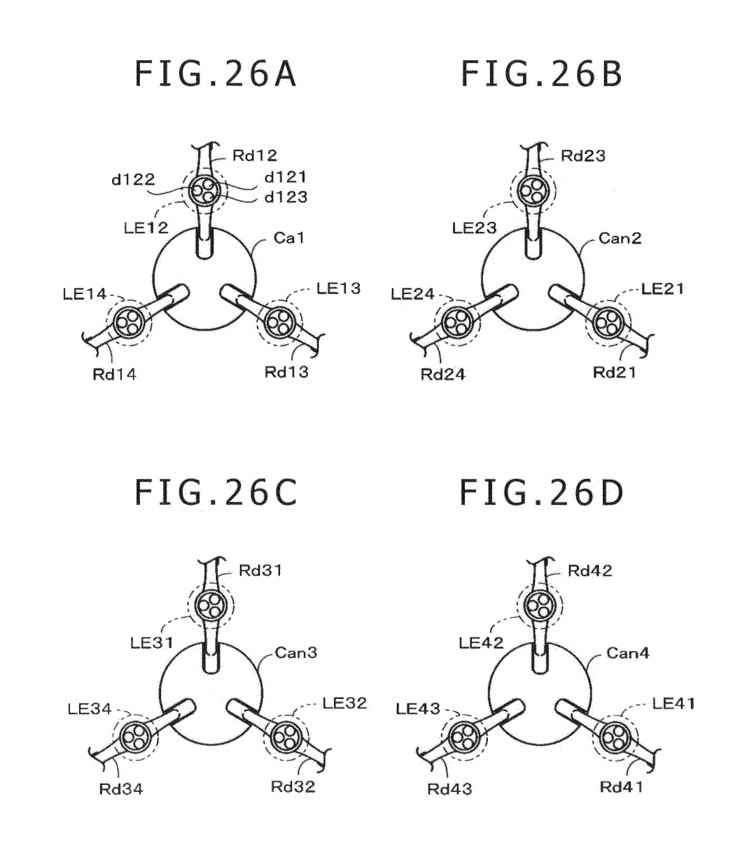

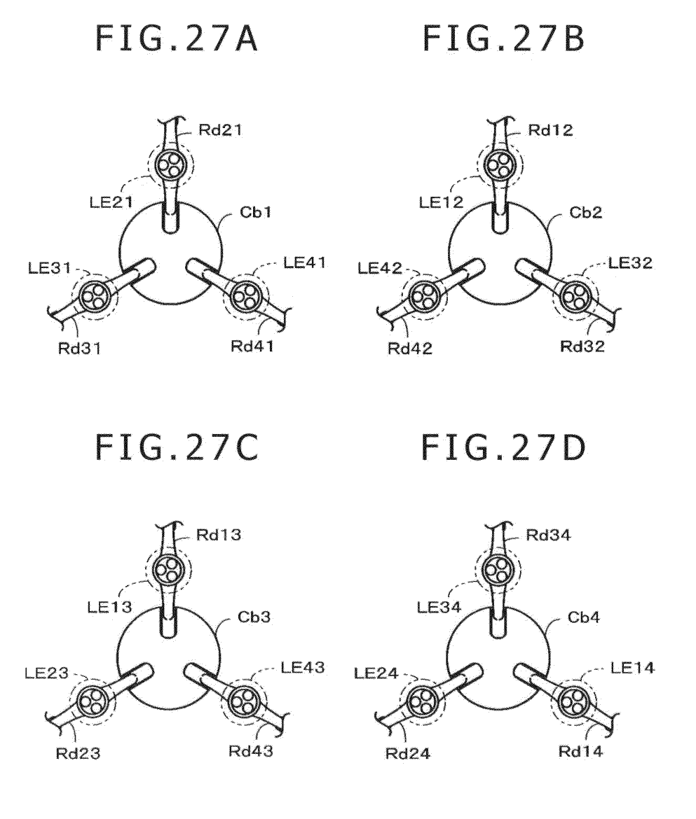

FIGS. 26A to 26D and FIGS. 27A to 27D are respectively schematic views showing the joint sites when viewed from the center of the support structure. FIGS. 26A to 26D respectively show the joint sites Ca1, Can2, Can3, and Can4 disposed at positions corresponding to the vertices of one regular tetrahedron when two regular tetrahedra are supposed, along with the rods coupled to the joint sites. In addition, FIGS. 27A to 27D respectively show the joint sites Cb1, Cb2, Cb3, and Cb4 disposed at positions corresponding to the vertices of the other regular tetrahedron of the two regular tetrahedra, along with the rods coupled to the joint sites.

As shown in FIGS. 26A to 26D, the joint sites Can2, Can3, and Can4 are joint sites on which a speaker is not disposed.

As shown in FIGS. 26A to 26D and FIGS. 27A to 27D, three rods are coupled to each of the joint sites Ca1, Can2, Can3, and Can4, and Cb1, Cb2, Cb3, and Cb4. Light emitting portions LE12, LE13, LE14, LE23, LE24, LE21, LE34, LE31, LE32, LE41, LE42, and LE43 are disposed, for example, at the centers of the rods Rd12, Rd13, Rd14, Rd23, Rd24, Rd21, Rd34, Rd31, Rd32, Rd41, Rd42, and Rd43 coupled to the eight joint sites described above, respectively. It is noted that a branch portion extending toward, the outside of the support structure is disposed on each rod on the side opposite to the light emitting portion.

### (Light Emitting Portions)

As shown in FIGS. 26A to 26D and FIGS. 27A to 27D, each of the light emitting portions is composed of, for example, a group of plural light emitting elements.

The configuration shown in FIGS. 26A to 26D and FIGS. 27A to 27D is an example in which the light emitting portions LE12, LE13, LE14, LE23, LE24, LE21, LE34, LE31, LE32, LE41, LE42, and LE43 are each composed of a group of three light emitting diodes (LEDs). For example, three LEDs d121, d122, and d123 are disposed in the light emitting portion LE12. Employing LEDs as the light emitting elements, sufficient brightness can be provided while suppressing the power consumption.

The number of light emitting diodes disposed in each of the light emitting portions can be suitably changed by a manufacturer of the lighting apparatus 21. The manufacturer of the lighting apparatus 21 may set the number of light emitting diodes disposed in each of the light emitting portions to 30, for example.

Organic Electroluminescence (EL) elements, fluorescent lamps or the like may be disposed either replacing the light emitting diodes or in addition to the light emitting diodes in each of the light emitting portions.

In the example of the configuration shown in FIGS. 26A to 26D and FIGS. 27A to 27D, the light emitting portions are disposed on the rods in such a way that they have symmetry and light emitted from each of the light emitting portions travels toward the center of the support structure. Therefore, the light emitted from each of the light emitting portions is emitted outside of the illuminator 22 through panels which will be described later or through a space defined between the panels.

It is noted that although the example of the configuration shown in FIGS. 26A to 26D and FIGS. 27A to 27D shows the case in which the light emitting portions are disposed at the centers of the rods, the disposition of the light emitting portions are by no means limited to this example. Meanwhile, preferably, the light emitting portions are disposed on at least part of the joint sites or rods selected from a set of the joint sites and the rods so as to have symmetry. The reason for this is because a user of the lighting apparatus 21 can then obtain light distribution with less bias.

### (Panels)

As shown in FIGS. 19A and 19B to FIGS. 24A and 24B, the illuminator 22 includes plural panels H12, H13, H14, H23, H24, H21, H34, H31, H32, H41, H42, and H43. In this case, the plural panels H12, H13, H14, H23, H24, H21, H34, H31, H32, H41, H42, and H43 correspond to the plural panels A12, A13, A14, A23, A24, A21, A34, A31, A32, A41, A42, and A43 of the sound-reproducing apparatus 11 of the first embodiment.

The panels H12, H13, H14, H23, H24, H21, H34, H31, H32, H41, H42, and H43, for example, are joined to the branch portions provided on the rods, respectively. Therefore, along with the shift of the lighting apparatus 21 from the accommodated state to the expanded state, the disposition of the panels joined to the head portions of the branches changes such that spaces between adjacent panels change and as if they are billowing.

The panels of the example of the configuration shown in FIGS. 19A and 19B to FIGS. 25A and 25B each adapts a form resembling a corallum or a honey comb. Such a form, for example, can as well be obtained by the algorithm design described above.

When the surfaces of the plural panels have a quasi-periodic shape or form, the design and functionality of the lighting apparatus 21 or the sound-reproducing apparatus 11 can be enhanced without reducing the overall symmetrical property of the lighting apparatus 21 or the sound-reproducing apparatus 11.

In the example of the configuration shown in FIGS. 19A and 19B to FIGS. 25A and 25B, each of the individual panels is configured as a set of units having plural side faces, and the inside and outside of the illuminator 22 are communicated through the space inside the plural side faces of each unit. Panels having such a complicated shape, for example, can also be manufactured in a short period of time by application of the rapid prototyping technology described above.

Since the plural panels have a function of a so-called lamp shade, more complicated and impressive shade can be provided the more complicated the forms of the individual panels become. In addition, when the lighting apparatus 21 is shifted between the accommodated state and the expanded state, along with the movement of the rods, the positions and angles of the individual panels in the whole change. Therefore, the user of the lighting apparatus 21 can enjoy an illuminance change different from that of the case where the electric power supplied to the fluorescent lamp or the like is changed, for example.

Examples of a material composing the panels are a resin material, metal material, sintered material such as ceramics, mineral, glass, paper, cloth, vegetative material and a composite material thereof. However, the material is not especially limited. For example, the plural panels may also be each made of a material having flexibility. When a flexible material is selected as the material composing the panels, the panels can be curved during the shift between the accommodated state and the expanded state of the support structure 2, thereby giving a change to the shapes of the individual panels.

For example, the manufacturer of the lighting apparatus can select a material having light permeability such as a transparent resin or a glass. Selecting a light permeable material as the material composing the panels, when the lighting apparatus 21 is in the expanded state, the user of the lighting apparatus 11 can enjoy the gorgeous atmosphere as if a chandelier is used.

It is noted that a reflecting member such as a metal deposited layer may be disposed on at least part of the inside or outside of the plural panels. Alternatively, a self-emission type element such as an organic EL element may be disposed on at least part of the inside or the outside of the plural panels. If the reflecting member and/or the self-emission type element is disposed on at least part of the inside or the outside of the panels, the user of the lighting apparatus 21 can create an even more resplendent atmosphere.

According to the lighting apparatus 21 of the second embodiment of the present disclosure, it is possible to obtain different illumination effects by shifting its state between the accommodated state and the exposure state. For example, when the user of the lighting apparatus 21 is quietly enjoying a meal with his or her family, the user can set the lighting apparatus 21 in the accommodated state, thereby creating a relaxed atmosphere. On the other hand, for example, when the user invites his or her friends for a party, the user can set the lighting apparatus 21 in the expanded state, thereby creating a resplendent atmosphere.

In addition, according to the lighting apparatus 21 of the second embodiment of the present disclosure, the positions and the angles of the panels, and may be the shapes thereof as well can be changed, allowing the light to be finely controlled. The life rhythm of the user of the lighting apparatus 21 can be improved, and it may also enrich the life of the user of the lighting apparatus.

### 3. Third Embodiment

### [Outline of Configuration of Sound-Reproducing Apparatus]

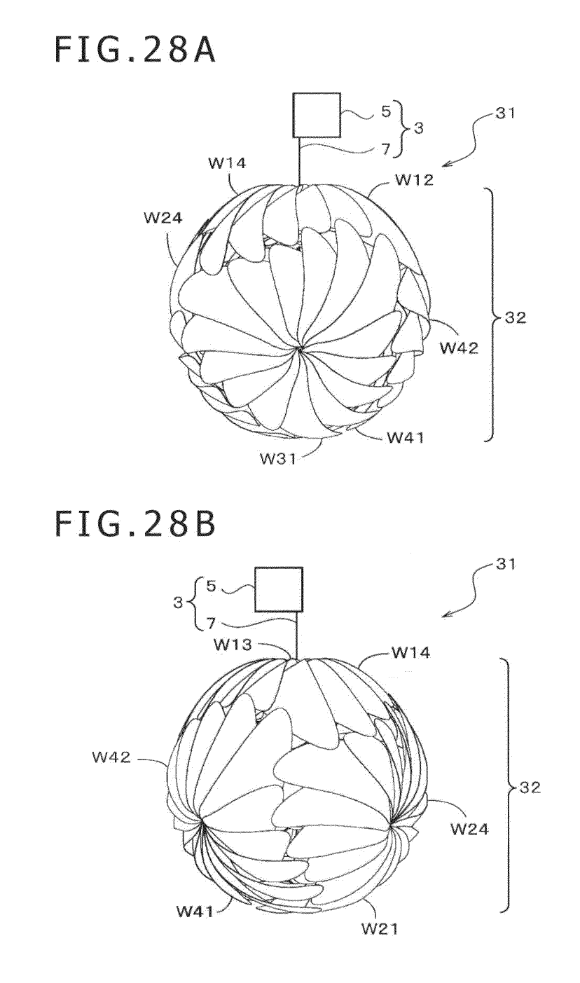

FIG. 28A is a front view showing an accommodated state of a sound-reproducing apparatus according to a third embodiment of the preset disclosure. FIG. 28B is a rear view showing the accommodated state of the sound-reproducing apparatus according to the third embodiment of the preset disclosure.

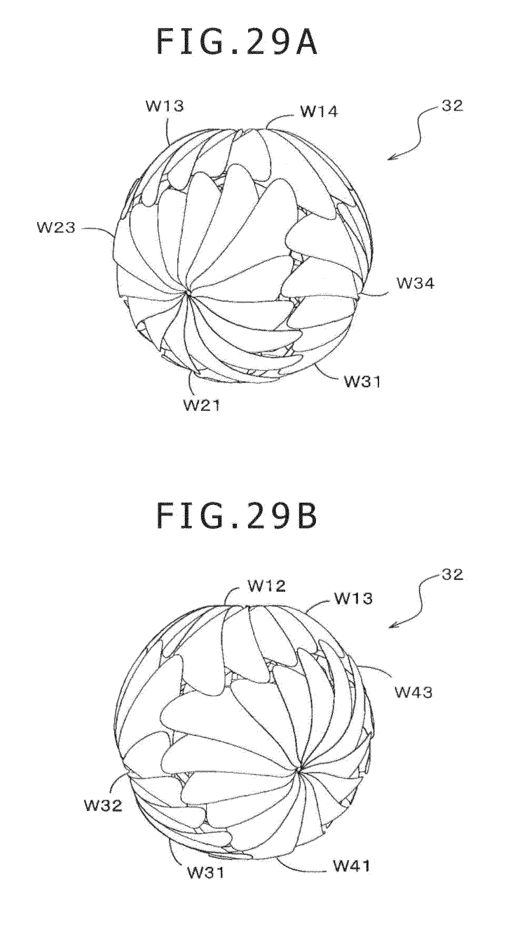

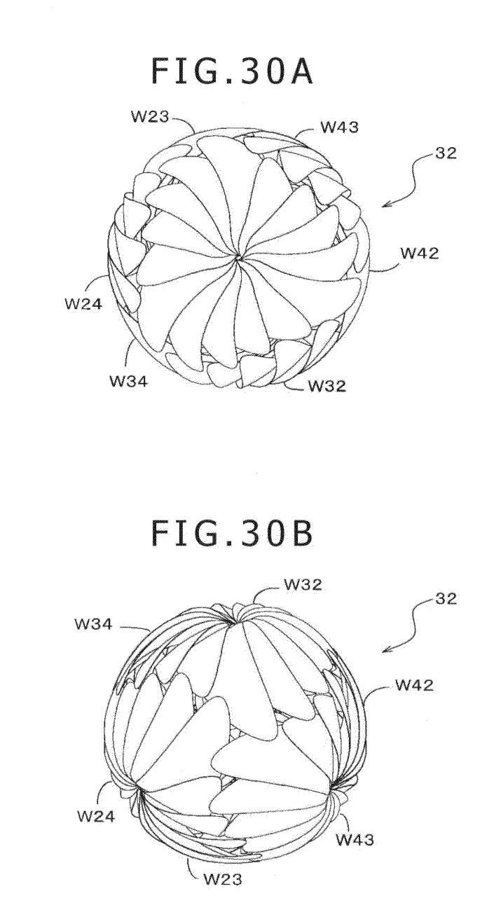

FIG. 29A is a right-hand side view showing an accommodated state of a sound-reproducing portion included in the sound-reproducing apparatus. FIG. 29B is a left-hand side view showing the accommodated state of the sound-reproducing portion. FIG. 30A is a top plan view showing the accommodated state of the sound-reproducing portion. FIG. 30B is a bottom plan view showing the accommodated state of the sound-reproducing portion.

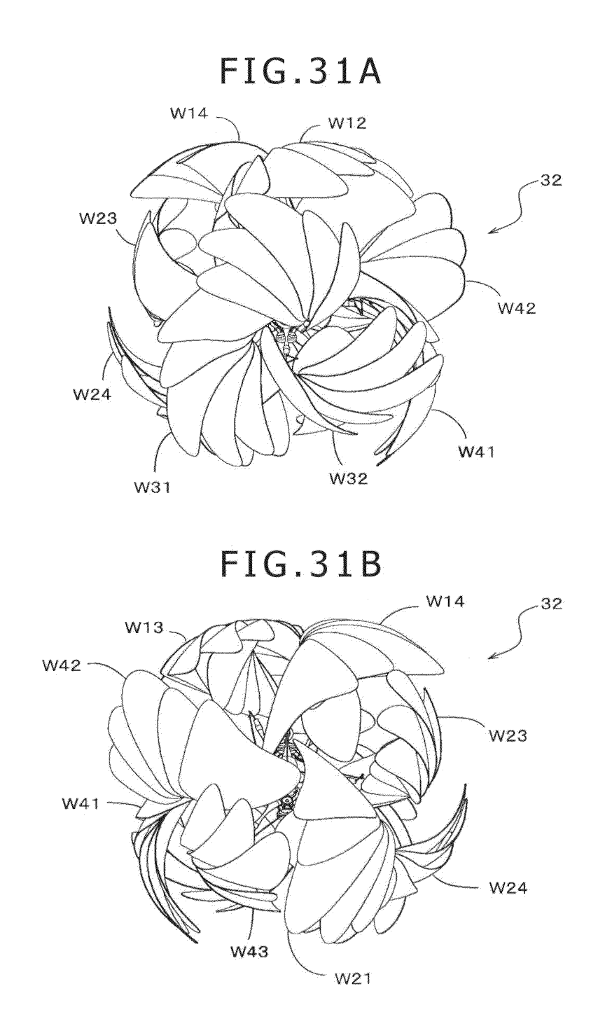

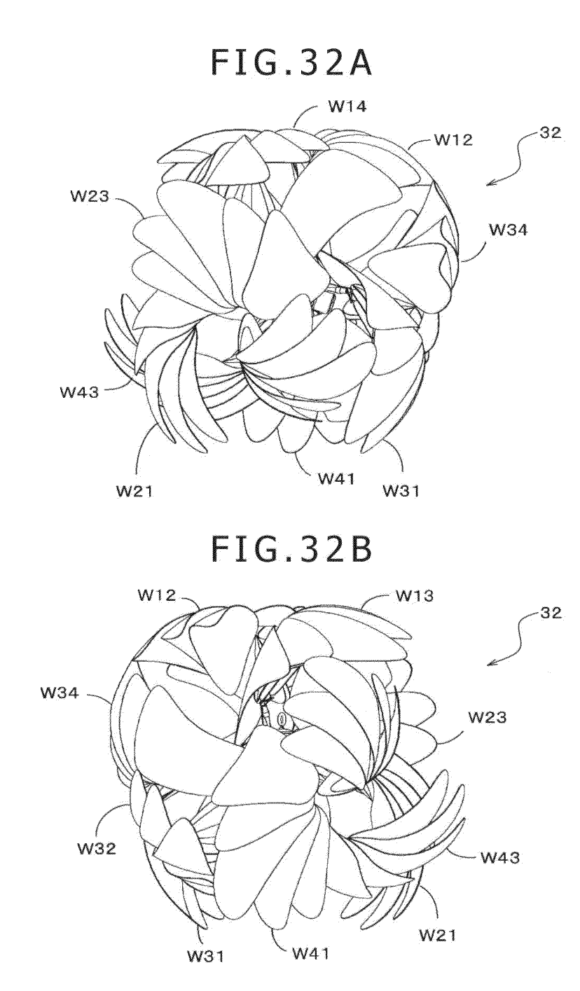

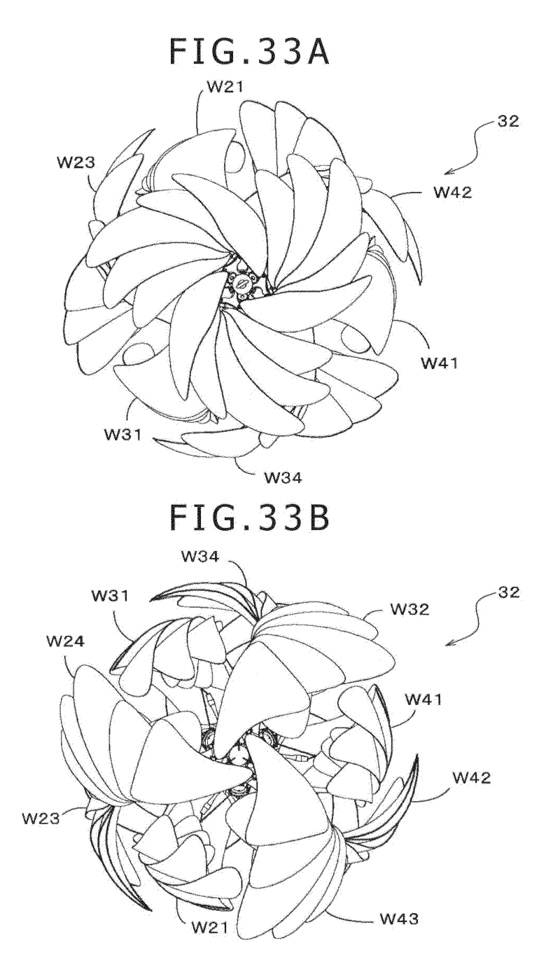

FIG. 31A is a front view showing an expanded state of the sound-reproducing portion. FIG. 31B is a rear view showing the expanded state of the sound-reproducing portion. FIG. 32A is a right-hand side view showing the expanded state of the sound-reproducing portion. FIG. 32B is a left-hand side view showing the expanded state of the sound-reproducing portion. FIG. 33A is a top plan view showing the expanded state of the sound-reproducing portion. FIG. 33B is a bottom plan view showing the expanded state of the sound-reproducing portion.

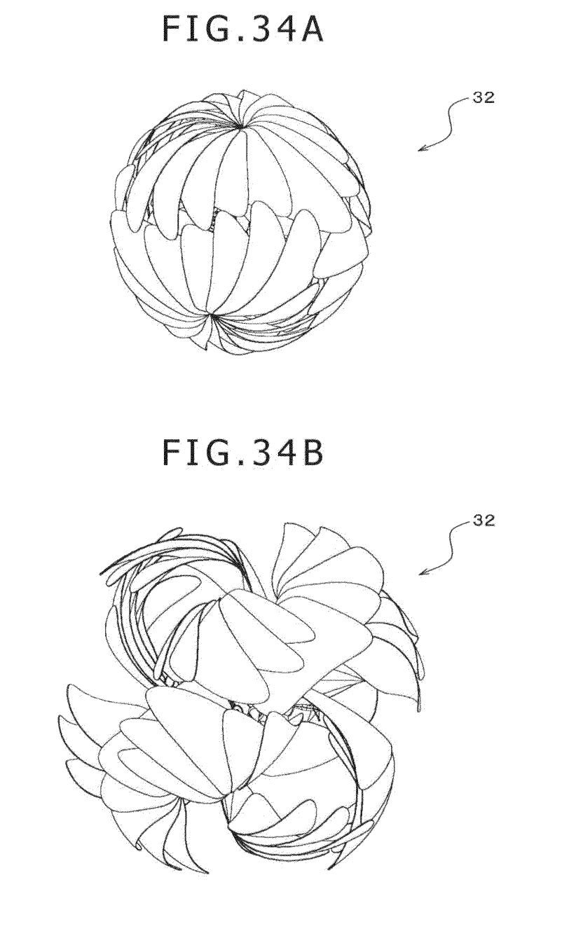

FIG. 34A is a perspective view showing the accommodated state of the sound-reproducing portion. FIG. 34B is a perspective view showing the expanded state of the sound-reproducing portion.

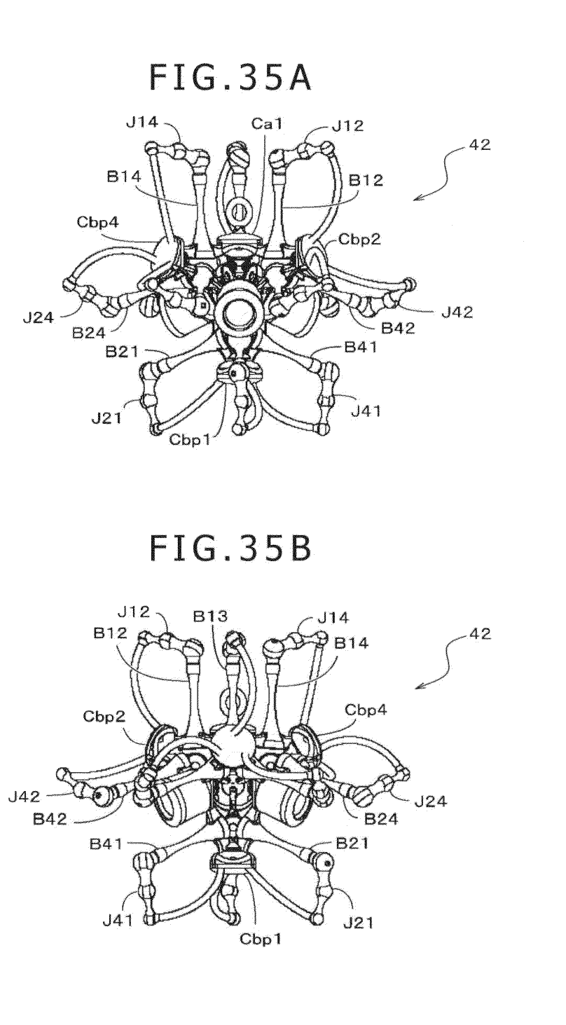

FIG. 35A is a front view showing an accommodated state of a support structure included in the sound-reproducing apparatus. FIG. 35B is a rear view showing the accommodated state of the support structure.

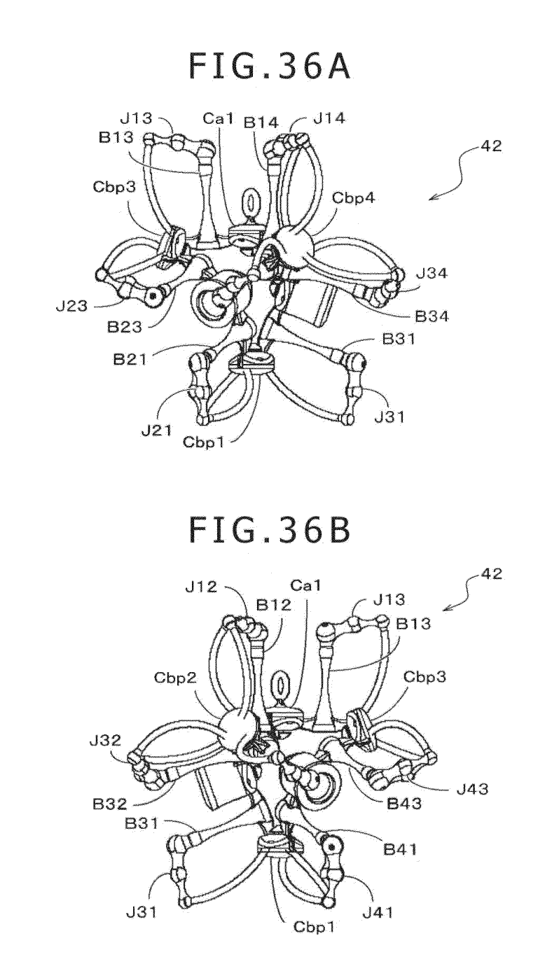

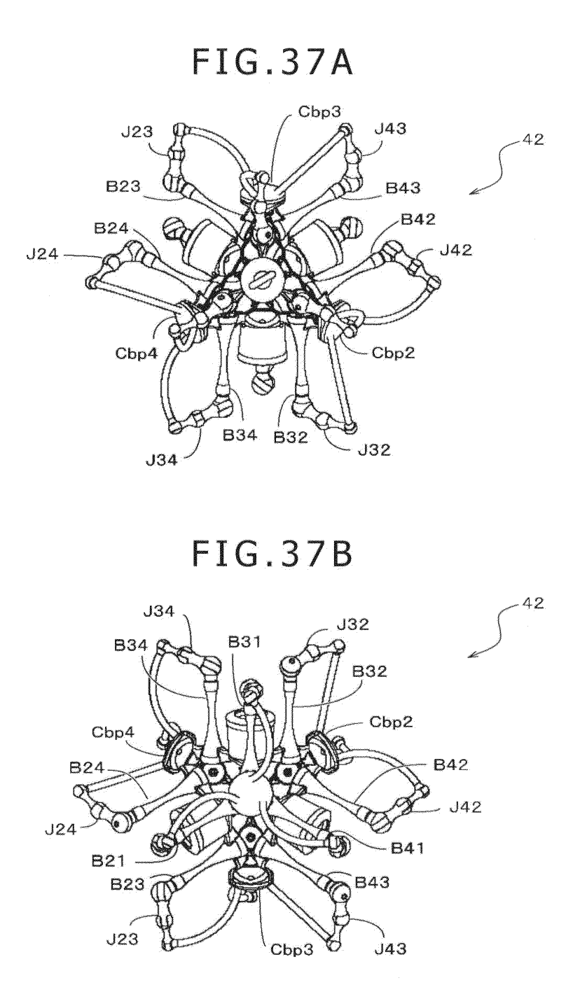

FIG. 36A is a right-hand side view showing the accommodated state of the support structure. FIG. 36B is a left-hand side view showing the accommodated state of the support structure. FIG. 37A is a top plan view showing the accommodated state of the support structure. FIG. 37B is a bottom plan view showing the accommodated state of the support structure.

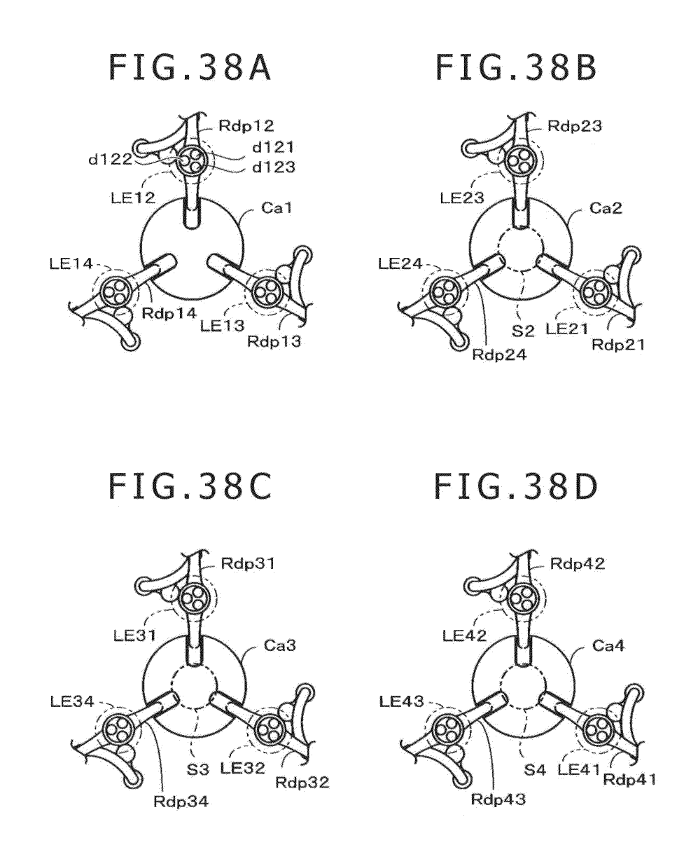

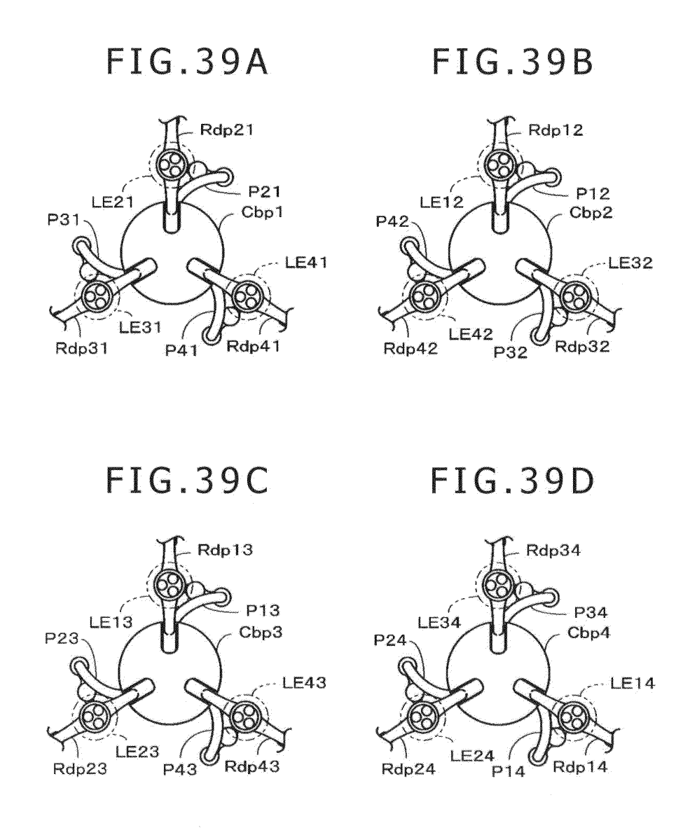

FIGS. 38A to 38D and FIGS. 39A to 39D are schematic views showing joint sites when viewed from the center of the support structure.

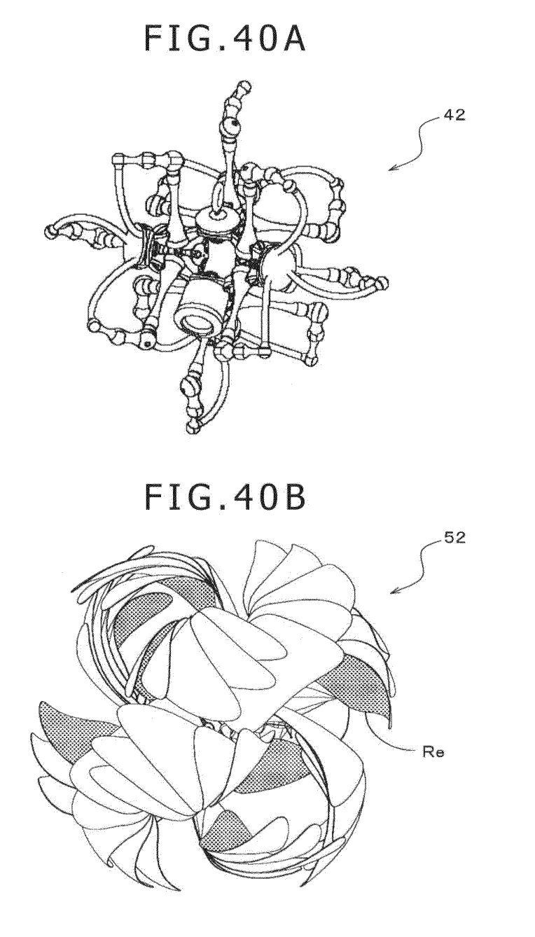

FIG. 40A is a perspective view showing the accommodated state of the support structure.

As shown in FIGS. 28A and 28B, the sound-reproducing apparatus 31 according to the third embodiment of the present disclosure includes an actuator 3 and the sound-reproducing portion 32 which includes plural panels.

The sound-reproducing portion 32 is identical to the sound-reproducing portion 12 in the first embodiment in that it incorporates a support structure that includes joint sites disposed at positions corresponding to the vertices of two regular tetrahedra in a duality relation, and rods connecting the joint sites. Therefore, the sound-reproducing apparatus 31 incorporating the support structure having the accommodated state and the expanded state also has the accommodated state and the expanded state.

The sound-reproducing apparatus 31 of the third embodiment is identical to the sound-reproducing apparatus 11 of the first embodiment in that the speakers S2, S3, and S4 are disposed on three of the plural joint sites. The speakers S2, S3, and S4 are disposed on joint sites located at positions corresponding to three of the vertices of one regular tetrahedron, respectively. The sound-reproducing apparatus 31 of the third embodiment is identical to the lighting apparatus 21 of the second embodiment in that plural light emitting portions are disposed on at least part of joint sites or rods selected from a set of the plural joint sites and plural rods so as to have symmetry.

That is to say, the sound-reproducing apparatus 31 of the third embodiment combines the functions of the sound-reproducing apparatus 11 of the first embodiment and the lighting apparatus 21 of the second embodiment. The sound-reproducing apparatus 31 of the third embodiment is an apparatus which could be referred to as a “pendant light type speaker.”

In addition, in the sound-reproducing apparatus 31 of the third embodiment, the support structure further includes plural arms. The plural arms have plural movable portions, and the arms couple the head of each rod with a joint site located at one of the positions corresponding to the vertices of the other regular tetrahedron. Note that, the third embodiment is identical to the first embodiment in that panels are joined to the plural rods, but the third embodiment differs from the first embodiment in that the panels are joined to the rods through their arms.

Next, the joint sites, the rods, the speakers, the light emitting portions, and the panels will be described in order with reference to FIGS. 28A and 28B to FIGS. 40A and 40B.

### (Joint Sites and Rods)

FIGS. 38A to 38D are views showing the joint sites Ca1, Ca2, Ca3, and Ca4 disposed at positions corresponding to the vertices of one regular tetrahedron when two regular tetrahedra are supposed, together with the rods coupled to the joint sites. FIGS. 39A to 39D are views showing joint sites Cbp1, Cbp2, Cbp3, and Cbp4 disposed at positions corresponding to the vertices of the other regular tetrahedron together with the rods coupled to the joint sites.

As shown in FIGS. 35A and 35B to FIGS. 39A to 39D, the support structure 42 includes the eight joint sites Ca1, Ca2, Ca3, and Ca4, and Cbp1, Cbp2, Cbp3, and Cbp4, and the twelve rods Rdp12, Rdp13, Rdp14, Rdp23, Rdp24, Rd221, Rdp34, Rdp31, Rdp32, Rdp41, Rdp42, and Rdp43. The joint sites Cbp1, Cbp2, Cbp3, and Cbp4 correspond to the joint sites Cb1, Cb2, Cb3, and Cb4 of the sound-reproducing apparatus 11 of the first embodiment, respectively.

As shown in FIGS. 35A and 35B to FIGS. 39A to 39D, the support structure 42 further includes the arms J12, J13, J14, J23, J24, J21, J34, J31, J32, J41, J42, and J43 connecting the branch portions provided on the rods with the joint sites Cbp1, Cbp2, Cbp3, and Cbp4.

As shown in FIGS. 39A to 39D, three supporting columns are provided for each of the joint sites Cbp1, Cbp2, Cbp3, and Cbp4. That is to say, the joint site Cbp1 is provided with the supporting columns P21, P31, and P41 each extending towards a different direction from a side opposite to the center of the support structure. Likewise, the joint site Cbp2 is provided with the supporting columns P32, P42, and P12; the joint site Cbp3 is provided with the supporting columns P43, P13, and P23; and the joint site Cbp4 is provided with the supporting columns P14, P24, and P34.

The individual arms J12, J13, J14, J23, J24, J21, J34, J31, J32, J41, J42, and J43 couple the branch portions B12, B13, B14, B23, B24, B21, B34, B31, B32, B41, B42, and B43 with the supporting columns provided for the joint sites Cbp1, Cbp2, Cbp3, and Cbp4. That is to say, the supporting columns P21 and the branch portion B21 are coupled by the arm 21, the supporting column P31 and the branch portion B31 ace coupled by the arm 31, and the supporting column P41 and the branch portion B41 are coupled by the arm 41. Likewise, the supporting columns P32 and the branch portion B32 are coupled by the arm 32, the supporting column P42 and the branch portion B42 are coupled by the arm 42, and the supporting column P12 and the branch portion B12 are coupled by the arm 12. The supporting columns P43 and the branch portion B43 are coupled by the arm 43, the supporting column P13 and the branch portion B13 are coupled by the arm 13, and the supporting column P23 and the branch portion B23 are coupled by the arm 23. The supporting columns P14 and the branch portion B14 are coupled by the arm 14, the supporting column P24 and the branch portion B24 are coupled by the arm 24, and the supporting column P34 and the branch portion B34 are coupled by the arm 34.

Three hinges, for example, are provided on each of the arms J12, J13, J14, J23, J24, J21, J34, J31, J32, J41, J42, and J43. The set of a joint site, supporting column, arm, rod (including the branch position), and hinge composes a link mechanism. That is to say, the individual arms J12, J13, J14, J23, J24, J21, J34, J31, J32, J41, J42, and J43 are transformed and moved along with the shift of the sound-reproducing apparatus 31 from the accommodated state to the expanded state.

As will be described later, the plural panels are mounted to the branch portions through the arms.

### (Speakers and Light Emitting Portions)

As shown in FIGS. 38A to 38D, the speakers S2, S3, and S4 are disposed on the three joint sites of the joint sites Ca1, Ca2, Ca3, and Ca4, excluding the joint site Ca1 coupled to the actuator 3. As shown in FIG. 16A, the positions where the speakers S2, S3, and S4 are disposed correspond respectively to the three vertices Va2, Va3, and Va4 of the regular tetrahedron Ta. The third embodiment is similar to the first embodiment in that when the sound-reproducing apparatus 31 shifts from the accommodated state to the expanded state, along with the movement of the joint sites Ca2, Ca3, and Ca4, the speakers S2, S3, and S4 appear from spaces defined by adjacent panels.

As shown in FIGS. 38A to 38D, the joint sites Ca1, Ca2, Ca3, and Ca4 are each coupled with three rods. In addition, as shown in FIGS. 39A to 39D, each of the joint sites Cbp1, Cbp2, Cbp3, and Cbp4 are also coupled with three rods.

Similarly to the case of the lighting apparatus 21 of the second embodiment, the light emitting portions LE12, LE13, LE14, LE23, LE24, LE21, LE34, LE31, LE32, LE41, LE42, and LE43, for example, are disposed on The centers of the rods Rdp12, Rdp13, Rdp14, Rdp23, Rdp24, Rdd21, Rdp34, Rdp31, Rdp32, Rdp41, Rdp42, and Rdp43, respectively. The rods are also provided with the branch portions extending toward the outside of the support structure 42 on the sides opposite to the light emitting portions. The arms J12, J13, J14, J23, J24, J21, J34, J31, J32, J41, J42, and J43 described above are attached to the heads of the branch portions, respectively.

The third embodiment is similar to the second embodiment in that light emitted from each of the light emitting portions is emitted toward the outside of the sound-reproducing portion 32 either through plural panels which will be described later or from the spaces defined between adjacent panels.

### (Panels)

As shown in FIGS. 28A and 28B to FIGS. 34A and 34B, the sound-reproducing portion 32 includes the plural panels W12, W13, W14, W23, W24, W21, W34, W31, W32, W41, W42, and W43. The plural panels W12, W13, W14, W23, W24, W21, W34, 31, W32, W41, W42, and W43 respectively correspond to the twelve panels A12, A13, A14, A23, A24, A21, A34, A31, A32, A41, A42, and A43 in the first embodiment, and also respectively correspond to the twelve panels H12, H13, H14, H23, H24, H21, H34, H31, H32, H41, H42, and H43 in the second embodiment.

The panels W12, W13, W14, W23, W24, W21, W34, W31, W32, W41, W42, and W43 are joined to the arms J12, J13, J14, J23, J24, J21, J34, J31, J32, J41, J42, and J43, respectively.

Therefore, as compared with the case where the panels are joined to the head portions of the branch portions, the positions and angles of the panels can be more largely changed between the accommodated state and the expanded state. Accordingly, the changes following the shift between the accommodated state and the expanded state in the sound of music or the like reproduced by the speakers S2, S3, and S4, and in the shade produced by the light distribution of the light emitted from the light emitting portions can be more enhanced. In addition, the degree of freedom of the design of the panels will be enhanced, thereby making it possible to provide a sound-reproducing apparatus having a higher design property.

In the example of the configuration shown in FIGS. 28A and 28B to FIGS. 34A and 34B, the panels are each constituted by five units having a petal-like shape, which as a whole form a wing-like shape. Such a shape, for example, may be obtained based on the algorithmic design described above. Even panels having such a complicated shape can be manufactured in a short period of time by applying she rapid prototyping technology described above. It is noted that the shapes of the units may be not perfectly identical to one another, and the shapes of the panels may each be a set of shapes that are varied little by little.

The panels have both of the functions of the sound reflector and the so-called lamp shade. In addition, when the lighting apparatus 31 is shifted between the accommodated state and the expanded state, along with the movement of the rods, the positions and angles of the individual panels in the whole change. Therefore, the user of the sound-reproducing apparatus 31 can shift the sound-reproducing apparatus 31 between the accommodated state and the expanded state in accordance with the situation, thereby making it possible to obtain different sound effects and illuminance changes.

FIG. 40B is a perspective view showing an example of a sound-reproducing portion in which reflecting members are disposed on the inner side the plural panels. In the example of the structure shown in FIG. 40B, mirror portions Re formed of a metal deposited layer, for example, are disposed on part of the inner sides of the individual panels. With the reflecting members disposed inside the panels, the light distribution of the light beams emitted from the light emitting portions in accordance with the shift from the accommodated state to the expanded state can be made more complicated and more gorgeous. It is noted that the mirror portions Re are represented by hatching in FIG. 40B.

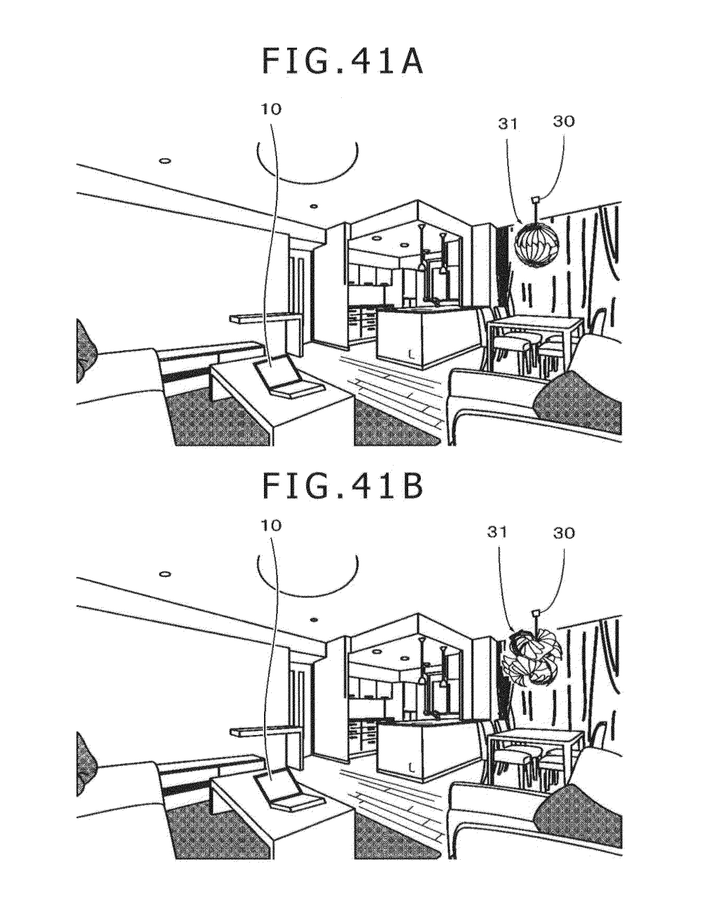

FIGS. 41A and 41B are views showing an example in which the sound-reproducing apparatus 31 of the third embodiment is installed on the ceiling of a dining room. FIGS. 41A and 41B respectively show a view where the sound-reproducing apparatus 31 is in the accommodated state, and a view where the sound-reproducing apparatus 31 is in the expanded state.

As shown in FIGS. 41A and 41B, the user of the sound-reproducing apparatus, for example, can install the sound-reproducing apparatus 31 on the ceiling of a dining room.

In general, electrical wiring is installed above the ceiling of a house, and a socket or the like to which a lamp is attached exists on the ceiling. Therefore, the user of the sound-reproducing apparatus 31 may attach the sound-reproducing apparatus 31 to the socket 30 or The like installed on the ceiling of a dining room. Alternatively, the user of the sound-reproducing apparatus 31 may directly or indirectly attach the sound-reproducing apparatus 31 to the ceiling of the dining room, and obtain electric power for operating components such as the actuator 3, the speakers S2, S3, and S4, and the light emitting portions through the socket 30 or the like. Note that, in this case, the changing between the accommodated state and the expanded state, for example, is carried out by the user of the sound-reproducing apparatus 31 manipulating a remote controller or by any other suitable method.

Music data or the like to be reproduced by the sound-reproducing apparatus 31, for example, may be transferred from a personal computer placed on a place different from the installation place of the sound-reproducing apparatus 31, a server apparatus installed in the house, and so forth. In the example of the configuration shown in FIGS. 41A and 41B, the music data or the like is transferred to the sound-reproducing apparatus 31 from a laptop type computer 10 placed on a table using a wireless system.

As a method for transferring the music data or the like, for example, it is possible to utilize communication using a wireless or wired system. Examples of communication using a wireless system are communication using infrared rays, “Bluetooth (registered trademark of Bluetooth SIG, Inc.),” ultra wide band (UWB), wireless local area network (LAN), “S-AIR (registered trademark by Sony Corporation),” and so forth, but the present disclosure is by no means limited thereto. On the other hand, examples of communication using a wired system are communication using an Internet line, optical line, telephone line, and so forth, but the present disclosure is by no means limited thereto. In addition, in such a case where the sound-reproducing apparatus 31 is attached to the socket or the like installed on the ceiling of a dining room, for example, it is also possible to employ communication through an electric power network.

The user of the sound-reproducing apparatus shifts the state between the accommodated state and the expanded state, thereby making it possible to softly partition the space without disposing a partition. For example, when the user is enjoying a meal quietly with his or her family, the user of the sound-reproducing apparatus sets the sound-reproducing apparatus in the accommodated state, so as to enjoy the relaxed illumination and music. On the other hand, for example, when the user invites his or her friends for a party, the user sets the sound-reproducing apparatus in the expanded state, so as to enjoy light and sound that spreads and echoes far.

According to embodiments of the present disclosure including the first and third embodiments, for example, the sound-reproducing apparatus may be installed on the ceiling of a dining room. There would be no need to dispose a heavy sound-reproducing apparatus to enjoy music, and it also prevents a room space being sacrificed. As a matter of course, the sound-reproducing apparatus may also be suspended from a floor stand or the like.

Disposing an omnidirectional sound-reproducing apparatus in the air, it may richly color the transition of feelings of the user of the sound-reproducing apparatus in his or her life.

### 4. Fourth Embodiment

### [Outline of Configuration of Suspended Opening and Closing Apparatus]

Preferred embodiments of the present disclosure include suspended opening and closing apparatuses such as those incorporated in the first to third embodiments. A suspended opening and closing apparatus according to a fourth embodiment of the present disclosure includes plural joint sites, plural rods, and an actuator. Assuming a first tetrahedron having the top vertex in a vertically upward direction and a second tetrahedron that is in a duality relation with the first tetrahedron, the plural joint sites are disposed at positions corresponding to the vertices of the first and second regular tetrahedra. The plural rods connect adjacent joint sites to each other among the plural joint sizes. The actuator is disposed above one of the plural joint sites that is disposed at a position corresponding to the top vertex of the first regular tetrahedron, and the actuator is connected to that one joint site.

### 5. Fifth Embodiment

### [Outline of Configuration of Suspended Opening and Closing Apparatus]

A suspended opening and closing apparatus according to a fifth embodiment of the present disclosure takes an accommodated state and an expanded state. The accommodated state and the expanded state are shifted to each other by operating an actuator disposed above. The suspended opening and closing apparatus of this embodiment includes plural members belonging to a first group, disposed so as to correspond to vertices of a first regular tetrahedron, and plural members belonging to a second group, disposed so as to correspond to vertices of a second regular tetrahedron. In one of the accommodated state and the expanded state, the first regular tetrahedron and the second regular tetrahedron have a duality relation.

With the sound reproduction apparatus or the lighting apparatus according to the embodiments of the present disclosure, it is possible to obtain different sound effects or illuminance effects by changing the state of the apparatus between the accommodated state and the expanded state. Further, according to the embodiments, the shifting between the accommodated state and the expanded state can be done freely with a small force by such a simple manipulation as operating one wire.

### 6. Modifications

Although several preferred embodiments of the present disclosure have been described so far, preferred embodiments of the present disclosure are by no means limited to those described above, and various kinds of modifications and alterations can be made within the scope of the appended claims or the equivalents thereof.

For example, the shape of the panels are by no means limited to those given in the embodiments described above, and the quantities and color tones of light emitted from the light emitting portions may not be identical.

In addition, for example, in the case where the sound-reproducing apparatus is connected to the socket or the like installed on the ceiling of a dining room, the sound-reproducing apparatus may be used as a tweeter with a speaker as a woofer disposed at a place different from the installation place of the sound-reproducing apparatus. The speaker as a woofer may be disposed in the vicinity of the ceiling on which the sound-reproducing apparatus is installed, or in the vicinity of the actuator.

The sound effect or the illumination effect of the sound-reproducing apparatus or the lighting apparatus, following the shifting between the accommodated state and the expanded state, can be changed in ways other than the user operating the sound-reproducing apparatus.

The changing between the accommodated state and the expanded state of the sound-reproducing apparatus or the lighting apparatus may also be carried out in accordance with the various kinds of environmental information. The environmental information may include information obtained via a network such as the Internet, and information obtained from various kinds of sensors such as a notion sensor and an image sensor.

Specific examples of the environmental information are time, weather, illuminance for a floor or a wall, room temperature or outdoor temperature, an action pattern of a user of the sound-reproducing apparatus or the lighting apparatus, a program on a television set being currently watched, the kind of cooking placed on a table, the number and motion of people in the room, a content of a book (including an electronic book) which a person in the room is reading, and so forth.

The sound-reproducing apparatus or the lighting apparatus may acquire and analyze one or more of those kinds of information, so that the sound-reproducing apparatus or the lighting apparatus operates actively. For example, the positions and shapes of the plural panels may be changed in accordance with the environmental condition, whereby the sound-reproducing apparatus or the lighting apparatus may suitably select or adjust the sound volume, music, quantity of light, color tone, and the like. It is not to mention that the state of the sound-reproducing apparatus or the lighting apparatus is not limited to the accommodated state and the expanded state. The sound-reproducing apparatus or the lighting apparatus may also be configured such that the apparatus operates to take an intermediate state between the accommodated state and the expanded state.

It is noted that one or more kinds of environmental information described above may be used in combination with one another as well. For example, the sound-reproducing apparatus or the lighting apparatus may actively provide light with an adjusted color tone and quantity according to information on time and information obtained from a motion sensor. The apparatus may further adjust the disposition of the panels, the sound, and the like.

The various kinds of environmental information may be acquired by the main body of the sound-reproducing apparatus or the main body of the lighting apparatus, or may be acquired from an attachment or a socket on a ceiling or a wall to which the main body of the sound-reproducing apparatus or the main body of the lighting apparatus is connected. Alternatively, for example, the various kinds of environmental information may also be acquired from any other suitable household electrical appliance or a server apparatus, a woofer disposed at a place different from that of the main body, a portable apparatus such as a smartphone or a mobile phone, and so forth.

According to embodiments of the present disclosure, the sound-reproducing apparatus or the lighting apparatus may actively control the sound volume, the music, the quantity of light, the color tone or the like, thereby enriching the life of the user of the sound-reproducing apparatus or the lighting apparatus. In addition, according to embodiments of the present disclosure, the sound or the light can be dynamically changed in accordance with the environment. The transition of feelings of the user of the sound-reproducing apparatus or the lighting apparatus in his or her life can be richly colored, and it may prompt an action or movement of mind of a person.

The sound-reproducing apparatus or the lighting apparatus according to the embodiments of the present disclosure, for example, can be installed in a wedding center, reception hall, restaurant, concert venue, hotel, dance hole, theater, movie theater, station, airport, school, and the like. Embodiments of the present disclosure, for example, can also be applied to a street light and the like in addition to the usage in buildings. For example, the sound-reproducing apparatus can be usually set in the accommodated state in order to reproduce a back-ground music, and at the time of a disaster or the like, the sound-reproducing apparatus can be set in the expanded state to be utilized as an emergency speaker.

It should be noted that the configurations, methods, shapes, materials, numerical values, and the like which have been given in the embodiments described above are merely examples, and the configurations, methods, shapes, materials, numerical values, and the like different from those may also be used. The configurations, methods, shapes, materials, numerical values, and the like which have been given in the embodiments described above can be combined with one another without departing from the spirit and scope of the present disclosure.

For example, the present disclosure may also adopt the following constitutions.

(1) A sound-reproducing apparatus, including: plural coupling portions disposed at positions corresponding to vertices of an assumed first regular tetrahedron and second regular tetrahedron in a duality relation with each other; plural rods connecting adjacent coupling portions to each other among the plural coupling portions; plural shell portions joined to the plural rods; an actuator disposed outside one coupling portion selected from the plural coupling portions with respect to a center of the first regular tetrahedron or a center of the second regular tetrahedron, the actuator being connected with the one coupling portion; and first, second, and third speakers disposed on, of the four coupling portions disposed at positions corresponding to the vertices of the one of the first and second regular tetrahedra including the one coupling portion, three coupling portions excluding the one coupling portion.

(2) The sound-reproducing apparatus described in paragraph (1), further including: plural links connecting the plural rods with the four coupling portions disposed at positions corresponding to the vertices of the other regular tetrahedron not including the one coupling portion, wherein the plural shell portions are joined to the plural rods through the plural links.

(3) The sound-reproducing apparatus described in paragraph (1) or (2), wherein the plural shell portions overlap with an adjacent shell portion when the actuator is in an expanded state.

(4) The sound-reproducing apparatus described in any one of paragraphs (1) to (3), wherein, of the plural shell portions, one or more shell portions have flexibility.

(5) The sound-reproducing apparatus described in any one of paragraphs (1) to (4), wherein each of the plural shell portions is constituted by a set of units of a shape.

(6) The sound-reproducing apparatus described in any one of paragraphs (1) to (5), wherein each of the plural shell portions has a quasi-periodic shape on a surface thereof.

(7) The sound-reproducing apparatus described in any one of paragraphs (1) to (6), further including plural light emitting portions disposed on at least part of the plural coupling portions or the plural rods, selected from a set of the plural coupling portions and the plural rods so as to have symmetry.

(8) The sound-reproducing apparatus described in paragraph (7), wherein the plural light emitting portions are disposed at central portions of the plural rods.

(9) The sound-reproducing apparatus described in paragraph (7) or (8), wherein each of the plural light emitting portions is constituted by a group of plural light emitting elements.

(10) The sound-reproducing apparatus described in paragraph (9), wherein the plural light emitting elements are light emitting diodes.

(11) The sound-reproducing apparatus described in any one of paragraphs (7) to (10), wherein each of the plural shell portions has light permeability.

(12) The sound-reproducing apparatus described in any one of paragraphs (7) to (11), further including one or more reflecting portions disposed on at least part of the plural shell portions.

(13) A lighting apparatus, including: plural coupling portions disposed at positions corresponding to vertices of an assumed first regular tetrahedron and second regular tetrahedron in a duality relation with each other; plural rods connecting adjacent coupling portions to each other among the plural coupling portions; plural shell portions joined to the plural rods; an actuator disposed outside one coupling portion selected from the plural coupling portions with respect to a center of the first regular tetrahedron or a center of the second regular tetrahedron, the actuator being connected with the one coupling portion; and plural light emitting portions disposed on at least part of the plural coupling portions or the plural rods, selected from a set of the plural coupling portions and the plural rods so as to have symmetry.

(14) A suspended opening and closing apparatus, including: plural coupling portions disposed at positions corresponding to vertices of an assumed first regular tetrahedron and second regular tetrahedron in a duality relation with each other, the first regular tetrahedron having a top portion thereof on a upper side in a vertical direction; plural rods connecting adjacent coupling portions to each other among the plural coupling portions; and an actuator disposed above one of the plural coupling portions disposed at a position corresponding to the top portion of the first regular tetrahedron, the actuator being connected with the one coupling portion.

(15) A suspended opening and closing apparatus having a first state and a second state, the first state and the second state being changed to each other by an operation of an actuator disposed above, wherein plural members belonging to a first group are disposed so as to correspond to vertices of a first regular tetrahedron, and plural members belonging to a second group are disposed so as to correspond to vertices of a second regular tetrahedron, and the first regular tetrahedron and the second regular tetrahedron are in a duality relation with each other in one of the first state and the second state.

The present disclosure contains subject matter related to that disclosed in Japanese Priority Patent Application JP 2011-203585 filed in the Japan Patent Office on Sep. 16, 2011, the entire content of which is hereby incorporated by reference.

What is claimed is:

1. A sound-reproducing apparatus, comprising:
plural coupling portions disposed at positions corresponding to vertices of an assumed first regular tetrahedron and second regular tetrahedron in a duality relation with each other;
plural rods connecting adjacent coupling portions to each other among said plural coupling portions;
plural shell portions joined to said plural rods;
an actuator disposed outside one coupling portion selected from said plural coupling portions with respect to a center of said first regular tetrahedron or a center of said second regular tetrahedron, said actuator being connected with said one coupling portion; and
first, second, and third speakers disposed or, of the four coupling portions disposed at positions corresponding to the vertices of the one of said first and second regular tetrahedra including said one coupling portion, three coupling portions excluding said one coupling portion.

2. The sound-reproducing apparatus according to claim 1, further comprising:
plural links connecting said plural rods with the four coupling portions disposed at positions corresponding to the vertices of the other regular tetrahedron not including said one coupling portion,
wherein said plural shell portions are joined to said plural rods through said plural links.

3. The sound-reproducing apparatus according to claim 1, wherein said plural shell portions overlap with an adjacent shell portion when said actuator is in an expanded state.

4. The sound-reproducing apparatus according to claim 1, wherein, of said plural shell portions, one or more shell portions have flexibility.

5. The sound-reproducing apparatus according to claim 1, wherein each of said plural shell portions is constituted by a set of units of a shape.

6. The sound-reproducing apparatus according to claim 1, wherein each of said plural shell portions has a quasi-periodic shape on a surface thereof.

7. The sound-reproducing apparatus according to claim 1, further comprising:
plural light emitting portions disposed on at least part of said plural coupling portions or said plural rods, selected from a set of said plural coupling portions and said plural rods sc as to have symmetry.

8. The sound-reproducing apparatus according to claim 7, wherein said plural light emitting portions are disposed at central portions of said plural rods.

9. The sound-reproducing apparatus according to claim 7, wherein each of said plural light emitting portions is constituted by a group of plural light emitting elements.

10. The sound-reproducing apparatus according to claim 9, wherein said plural light emitting elements are light emitting diodes.

11. The sound-reproducing apparatus according to claim 7, wherein each of said plural shell portions has light permeability.

12. The sound-reproducing apparatus according to claim 7, further comprising:
one or more reflecting portions disposed on at least part of said plural shell portions.

13. A lighting apparatus, comprising:
plural coupling portions disposed at positions corresponding to vertices of an assumed first regular tetrahedron and second regular tetrahedron in a duality relation with each other;
plural rods connecting adjacent coupling portions to each other among said plural coupling portions;
plural shell portions joined to said plural rods;
an actuator disposed outside one coupling portion selected from said plural coupling portions with respect to a center of said first regular tetrahedron or a center of said second regular tetrahedron, said actuator being connected with said one coupling portion; and
plural light emitting portions disposed on at least part of said plural coupling portions or said plural rods, selected from a set of said plural coupling portions and said plural rods so as to have symmetry.

14. A suspended opening and closing apparatus, comprising:
plural coupling portions disposed at positions corresponding to vertices of an assumed first regular tetrahedron and second regular tetrahedron in a duality relation with each other, said first regular tetrahedron having a top portion thereof on a upper side in a vertical direction;
plural rods connecting adjacent coupling portions to each other among said plural coupling portions; and
an actuator disposed above one of said plural coupling portions disposed at a position corresponding to said top portion of said first regular tetrahedron, said actuator being connected with said one coupling portion.

15. A suspended opening and closing apparatus having a first state and a second state, the first state and the second state being changed to each other by an operation of an actuator disposed above,
wherein plural members belonging to a first group are disposed so as to correspond to vertices of a first regular tetrahedron, and plural members belonging to a second group are disposed so as to correspond to vertices of a second regular tetrahedron, and
said first regular tetrahedron and said second regular tetrahedron are in a duality relation with each other in one of the first state and the second state.
